(19) United States
(12) Patent Application Publication
(10) Pub. No.: US 2010/0046755 A1
(43) Pub. Date: Feb. 25, 2010

(54) Cryptography related to keys with signature

(75) Inventor: Michael S. Fiske, San Francisco, CA (US)

Correspondence Address: Michael Fiske, P.O. Box 475178, San Francisco, CA, 94147, US

(73) Assignee: Fiske Software LLC

(21) Appl. No.: 12/584,437

(22) Filed: Sep. 4, 2009

Related U.S. Application Data
(63) Continuation-in-part of application No. 11/298,366, filed on Dec. 8, 2005.
Application No. 11/298,366 is a continuation-in-part of application No. 11/298,169, filed on Dec. 7, 2005.

(51) Int. Cl. H04L 9/00; H04L 9/08

(52) U.S. Cl. 380/256; 380/255; 380/278

(57) ABSTRACT

In one embodiment, messages are encrypted with encrypted transformations that commute with one another. In another embodiment, a message is divided into message segments, and with each encrypted message segment one or more encrypted keys are sent. The encrypted keys may be used to decrypt a message segment that is sent at another time, such as the next message segment to be sent. In another embodiment, a sender encrypts a message with a first encryption, which may be unknown to the receiver. Then a receiver encrypts the message with a second encryption. Next the sender removes the first encryption, thereby allowing the receiver to reconstitute the original message by removing the second encryption. In another embodiment, a sender encrypts a message with a first encryption and a signature. Then a receiver encrypts the message with a second encryption. Next the sender removes the first encryption, thereby allowing the receiver to reconstitute the original message by removing the second encryption and the signature.

### RELATED APPLICATIONS

This application is a continuation-in-part of U.S. patent application Ser. No. 11/298,169, entitled “Cryptography Related to Keys,” filed Dec. 8, 2005. This application claims priority benefit of U.S. patent application Ser. No. 11/298,169, entitled “Cryptography Related to Keys,” filed Dec. 8, 2005, which is incorporated herein by reference. This application claims priority benefit of U.S. Provisional Patent Application Ser. No. 60/679,169, entitled “Lock Cryptography with Initial Key,” filed May 9, 2005, which is incorporated herein by reference. This application also claims priority benefit of and also incorporates by reference U.S. Provisional Patent Application No. 60/634,955, entitled “Multiple Lock Cryptography,” filed Dec. 10, 2004. This application incorporates by reference U.S. Provisional Patent Application, 60/424,299, entitled “Non-Autonomous Dynamical Orbit Cryptography,” filed Nov. 6, 2002. This application also incorporates by reference U.S. patent application, Ser. No. 10/693,053, entitled “Non-Autonomous Dynamical Orbit Cryptography,” filed Oct. 25, 2003, which is also Publication No. US-2004-0228480-A1.

### FIELD

The specification generally relates to securely transmitting and storing information. It also may relate to securely transporting and storing physical goods such as gold, nuclear materials and other valuables.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Cryptographic devices and methods are generally used to encrypt and decrypt information transmitted through communication and transmission systems. However, cryptographic devices and methods may also be used to encrypt passive data stored on a computer or another physical device such as a tape drive or flash memory. A plaintext message may be encrypted by a sender using a unique key, and the encrypted message, called ciphertext, is transmitted to a receiver. Using the same key (symmetric) or a distinct key, the receiver may apply a decryption device or method to the ciphertext. The output of this decryption device or method is expected to be the same plaintext message that the sender gathered before encrypting and sending the plaintext message.

In some communication and transmission systems, it is useful to protect against what is called a “man-in-the-middle”. An example of a “man-in-the-middle” during communication is presented in the next paragraph:

“Alice and Bob want to securely communicate. Alice knows she is communicating with somebody, but she does not know whom she is communicating with. Eve can sit in the middle of the communication and pretend to be Bob when speaking to Alice, and Eve can pretend to be Alice when speaking to Bob. In some cases, there is no way in which Alice can detect she is talking to Eve, and not Bob. The same problem holds for Bob. Eve can keep up with this deception for as long as she likes. Suppose Alice and Bob start to communicate with using a secret key they think they have set up. All Eve needs to do is forward all the communications between Alice and Bob.” [See Bruce Schneier.]

Man-in-the-middle attacks exploiting the browser are able to create security breaches in even what are considered as strong security systems such as SSL and PKI that utilize what is considered as strong cryptographic methods. [See Philipp Gühring, “Concepts against Man-in-the-Browser Attacks” Jan. 27, 2007]

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a message system for sending encrypted messages.

FIG. 2 shows a block diagram of an algorithm for performing encryption.

FIG. 3 shows TABLE 1, which is a truth table for the exclusive-or operator.

FIG. 4 shows TABLE 2, which shows an example of an operator that is formed by a bitwise application of the exclusive-or operator.

FIG. 5 shows TABLE 3, which is a truth table for the biconditional operator.

FIG. 6 shows a block diagram of a machine that may be an embodiment of a message machine, which could be used as the sending machine or receiving machine of FIG. 1.

FIG. 7 shows an example of a timing diagram that illustrates using the random time intervals of a Geiger counter to generate bit values.

FIG. 8 shows a method for transferring information in which both the sender and receiver possess the same key prior to sending any messages.

FIG. 9 is a method for encrypting and sending a message that is divided into message segments.

FIG. 10 shows a flowchart of an embodiment of a method for receiving and reconstituting the message sent by the method of FIG. 9.

FIG. 11 shows a flowchart of an embodiment of a method of transmitting messages while using any number of keys.

FIG. 12 shows a flowchart of an embodiment of a method for implementing one of the steps of the method of FIG. 11.

FIG. 13 shows a TABLE 4 of an example of a transmission that a sender may send to a receiver via the method of FIG. 9.

FIG. 14 shows a TABLE 5. The contents of TABLE 5 are a more specific example of the transmission described more generally in conjunction with TABLE 4.

FIG. 15 shows a TABLE 6 of the decryption computations performed by the receiver.

FIG. 16 shows a TABLE 7. The contents of TABLE 7 are a more specific example of the computations described more generally in conjunction with TABLE 6.

FIGS. 17 and 18A show TABLEs 8 and 9, respectively, which show an example of the first three transmissions for a situation in which two new keys are generated.

FIGS. 18B(1)-18F show different embodiments that use composite keys for encryption.

FIG. 19 shows a flowchart of an embodiment of a method for exchanging encrypted messages without necessarily exchanging any keys.

FIG. 20 shows a flowchart of an example of a method of making the messaging system of FIG. 1.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

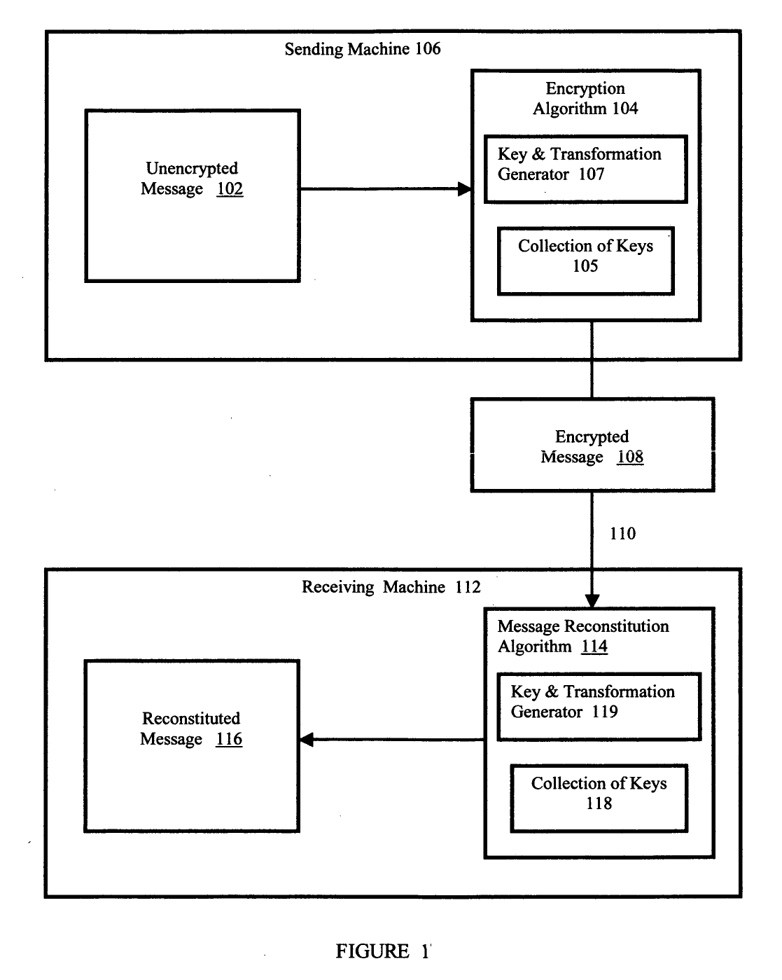

In general, at the beginning of the discussion of each of FIGS. 1-9 is a brief description of each element, which may have no more than the name of each of the elements in the particular figure that is being discussed. After the brief description of each element, each element of FIGS. 1-9 is further discussed in numerical order. In general, each of FIGS. 1-20 is discussed in numerical order, and the elements within FIGS. 1-20 are also usually discussed in numerical order to facilitate easily locating the discussion of a particular element. Nonetheless, there is not necessarily any one location where all of the information of any element of FIGS. 1-20 is located. Unique information about any particular element or any other aspect of any of FIGS. 1-20 may be found in, or implied by, any part of the specification.

In various places of the specification a letter is used to refer to a particular numerical value. Unless indicated otherwise, the numerical values represented by these letters are unrelated to one another. Specifically, even though one letter (e.g., “m” or “n”) comes earlier in the alphabet than another letter (e.g., “n” or “p,” respectively), the order of these letters in the alphabet does not mean that the earlier letter represents a smaller number. The value of the earlier letter is unrelated to the later letter, and may represent a value that is greater the same or less than the later letter.

FIG. 1 shows a message system 100 for sending messages in a manner that is expected to be secure. Message system 100 includes an unencrypted message 102, an encryption algorithm 104, a collection of keys 105, a sending machine 106, a key and transformation generator 107, an encrypted message 108, a transmission path 110, a receiving machine 112, a message reconstitution algorithm 114, a reconstituted message 116, and a collection of keys 118. In other embodiments, message system 100 may not have all of the components listed above or may have other components instead of and/or in addition to those listed above.

Message system 100 may be used for transmitting encrypted messages. Unencrypted message 102 may be a message that has not been encrypted yet (e.g., unencrypted message 102 may include plaintext), that is intended to be delivered to another location, software unit, machine, person, or other entity. In this specification, the term location may refer to geographic locations and/or storage locations. A particular storage location may be a collection of contiguous and/or noncontiguous locations on one or more machine readable media. Two different storage locations may refer to two different sets of locations on one or more machine-readable media in which the locations of one set may be intermingled with the locations of the other set. In this specification, the term “machine-readable medium” is used to refer to any medium capable of carrying information that is readable by a machine. One example of a machine-readable medium is a computer-readable medium. Another example of a machine-readable medium is paper having holes that are detected that trigger different mechanical, electrical, and/or logic responses. The term machine-readable medium also includes media that carry information while the information is in transit from one location to another, such as copper wire and/or optical fiber and/or the atmosphere and/or outer space.

It may be desirable to keep the contents of unencrypted message 102 secret. Consequently, it may be desirable to encrypt unencrypted message 102, so that the message is expected to be unintelligible to an unintended recipient should the unintended recipient attempt to read and/or decipher the message transmitted. Unencrypted message 102 may be a collection of multiple messages, an entire message, a message segment, or any other portion of a message.

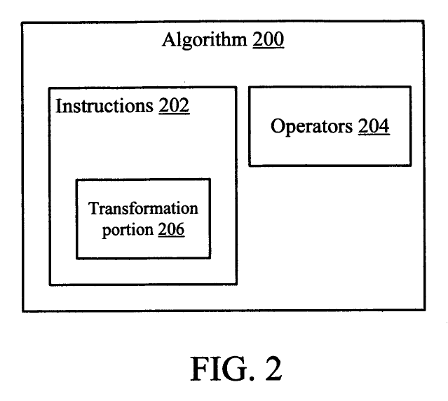

Encryption algorithm 104 may be a series of steps that are performed to encrypt unencrypted message 102. In this specification, the term “algorithm” refers to a series of one or more operations. In one embodiment, the term “algorithm” refers to one or more instructions for carrying out the series of operations that may be stored on a machine-readable medium. Alternatively, the algorithm may be carried out by and therefore refer to hardware (e.g., logic circuits) or may be a combination of instructions stored on a machine-readable medium and hardware that cause the operations to be carried out. Unencrypted message 102 may be an input for encryption algorithm 104. The steps that are included in encryption algorithm 104 may include one or more mathematical operations and/or one or more other operations. These operations along with the key(s) are components of transformations created in key and transformation generator 107. For example, encryption algorithm 104 may apply a transformation that is a single mathematical formula or the transformation may include a series of mathematical operations applied to a binary or other representation of the message 102. As another example, encryption algorithm 104 may apply a transformation that is a sequence of substitution and/or conversion rules (such as applying a binary bit operator to a randomly generated key and the bits that make up the message or other conversion rules) applied to the symbols and/or words of message 102. An embodiment in which encryption algorithm 104 includes an application of mathematical operators to a binary representation of message 102 is discussed below, in conjunction with FIG. 2. After applying a transformation—created in key and transformation generator 107—to unencrypted message 102, the output of encryption algorithm 104 is an encrypted message.

Collection of keys 105 may include one or more keys, which may be grouped into one or more groups of keys and/or sets of keys. Collection of keys 105 may be used by encryption algorithm 104 to encrypt at least part of unencrypted message 102. For example, encryption algorithm 104 may include one or more binary operations that use unencrypted message 102 as one input and at least part of at least one key of collection of keys 105 as another input to produce an output. In this specification, a binary operator is any operator that has two inputs and at least one output. In an embodiment, one or more keys of collection of keys 105 are generated by the key and transformation generator 107 in encryption algorithm 104. Similarly, one or more keys of collections of keys 118 are generated by key and transformation generator 119 in reconstitution algorithm 114 (e.g., a decryption algorithm). By using a collection of keys 105, multiple parties may use the same encryption algorithm i.e. the same transformations, but are still not expected to be able to decrypt one another's messages unless they use the same key of collection of keys 105.

In other embodiments, encryption algorithm may generate different transformations from key and transformation generator 107, than the transformations generated by key and transformation generator 119 of message reconstitution algorithm (e.g. decryption algorithm) 114.

Collection of keys 105 may be a broad range of sizes. For example, if the size of a key from collection of keys 105 is measured in bits, one or more keys within collection of keys 105 may be 64 bits, 128 bits, 512 bits, 1000 bits, 1024 bits, 4096 bits or larger. The number of keys in collection of keys 105 may change and/or the actual keys included in collection of keys 105 may change while sending a message.

Key and transformation generator 107 generates keys and transformations that are used by encryption algorithm 104 and collection of keys 105. A transformation is portion of code and/or a portion of hardware that transforms a message into a different representation. In some embodiments, the keys and/or transformations generated will be determined using the quantum properties of a physical system that makes up a portion of the hardware. In some embodiments, a portion of code may interpret or map these quantum properties to one or more keys or transformations. In some embodiments, the quantum properties may be useful for generating unpredictable keys and/or transformations. Unpredictability or randomness is useful in generating secure cryptographic methods.

Sending machine 106 may be a message machine that handles messages at or is associated with a first location, software unit, machine, person, sender, or other entity. Sending machine 106 may be a computer, a phone, a telegraph, another type of electronic device, a mechanical device, or other kind of machine that sends messages. Sending machine 106 may include one or more processors and/or may include specialized circuitry for handling messages. Sending machine 106 may receive unencrypted message 102 from another source, may produce all or part of message 102, may implement encryption algorithm 104, and/or may transmit the output of algorithm 104 to another entity. In another embodiment, sending machine 106 receives unencrypted message 102 from another source, while encryption algorithm 104 and the delivery of the output of encryption algorithm 104 are implemented manually. In another embodiment, sending machine 106 implements encryption algorithm 104, having unencrypted message 102 entered, via a keyboard (for example), into sending machine 106. In another embodiment, sending machine 106 receives output from encryption algorithm 104 and sends the output to another entity. In an embodiment, sending machine 106 may create new keys in key and transformation generator 107 for collection of keys 105 and/or for other message machines. Throughout this specification other embodiments may be obtained by substituting a human being, software, or other entity for the sending machine 106.

Encrypted message 108 includes at least some text that is encrypted (e.g., ciphertext). Encrypted message 108 is generated from unencrypted message 102. However, the content of encrypted message 108 that is from unencrypted message 102 is encrypted within encrypted message 108, but unencrypted within unencrypted message 102. Encrypted message 108 may be the output of encryption algorithm 104, which may be transmitted by sending machine 106. A key chosen from collection of keys 105 may be used as a second input for encrypting a part of or all of unencrypted message 102, and collection of keys 105 may facilitate decrypting and/or partially decrypting encrypted message 108, which was encrypted using collection of keys 105.

Transmission path 110 is the path taken by encrypted message 108 to get to the destination to which encrypted message 108 was sent. Transmission path 110 may include one or more networks. For example, transmission path 110 may be the Internet. Transmission path 110 may include any combination of any of a direct connection, hand delivery, vocal delivery, one or more Local Area Networks (LANs), one or more Wide Area Networks (WANs), one or more phone networks, and/or one or more wireless networks, including wireless paths under the ground and/or inside and/or outside the earth's atmosphere.

Receiving machine 112 may be a message machine that handles messages at the destination of an encrypted message 108. Receiving machine 112 may be a computer, a phone, a telegraph, another type of electronic device, a mechanical device, or other kind of machine that receives messages. Receiving machine 112 may include one or more processors and/or specialized circuitry configured for handling messages, such as encrypted message 108. Receiving machine 112 may receive encrypted message 108 from another source and/or reconstitute (e.g., decrypt) all or part of encrypted message 108. In one embodiment, receiving machine 112 only receives encrypted message 108 from transmission path 110, while encryption algorithm 104 is implemented manually and/or by another message machine. In another embodiment, receiving machine 112 implements a reconstitution algorithm that reproduces all or part of message 102. In another embodiment, receiving machine 112 receives encrypted massage 108 from transmission path 110, and reconstitutes all or part of unencrypted message 102. Receiving machine 112 may be identical to sending machine 106. For example, receiving machine 112 may receive unencrypted message 102 from another source, produce all or part of unencrypted message 102, and/or implement encryption algorithm 104. Similar to sending machine 106, receiving machine 112 may generate keys. Receiving machine 112 may transmit the output of algorithm 104, via transmission path 110 to another entity and/or receive encrypted message 108 (via transmission path 110) from another entity. Receiving machine 112 may present encrypted message 108 for use as input to reconstitution algorithm 114 and/or implement reconstitution algorithm 114. Throughout this specification other embodiments may be obtained by substituting a human being, software, and/or another entity for the receiving machine 112.

Reconstitution algorithm 114 at least partially reconstitutes at least part of unencrypted message 102 based on encrypted message 108. Reconstitution algorithm 114 may use encrypted message 108 and a key as inputs and produce unencrypted message 102 as an output. In an embodiment, reconstitution algorithm 114 may be implemented by receiving machine 112. In an embodiment (which may or may not be the same embodiment), reconstitution algorithm 114 may receive input (e.g., encrypted message 108) from transmission path 110 and/or receiving machine 112. Reconstitution algorithm 114 and encryption algorithm 104 may be different portions of the same algorithm and/or the same algorithm implemented with a different set of parameters and/or other inputs. In an embodiment, reconstitution algorithm 114 reconstitutes unencrypted message 102 by inverting encryption algorithm 104. In an embodiment, inverting encryption algorithm 104 is accomplished by applying encryption algorithm 104 a second time.

Collection of keys 118 may include one or more keys, which may be used by reconstitution algorithm 114 to at least partially reconstitute encrypted message 108. In an embodiment, one or more keys of collection of keys 118 are generated by encryption algorithm 104 and/or reconstitution algorithm 114. Collection of keys 118 may be the same as collection of keys 105, in which case reconstitution algorithm 114 may be capable of completely reconstituting unencrypted message 102 by decrypting encrypted message 108.

Key and transformation generator 119 generates keys and transformations that are used by reconstitution algorithm 114 and collection of keys 118. In some embodiments, the keys and/or transformations generated in 119 will be determined using the quantum properties of a physical system that makes up a portion of the hardware. In some embodiments, a portion of code may interpret or map these quantum properties to one or more keys or transformations.

In another embodiment, collection of keys 118 is different from collection of keys 105. In an embodiment, encryption algorithm 104 may use an encryption that requires a different key for decryption than is used for encryption. In this embodiment, collection of keys 118 may include one or more decryption keys. In an embodiment, new keys are sent from collection of keys 105 of sending machine 106 to collection of keys 118 for use in reconstituting encrypted message 108. In an embodiment, collection of keys 118 may include keys for reconstituting messages and for encrypting other messages.

In another embodiment, after using collection of keys 105 for the encryption of encrypted message 108, reconstitution algorithm 114 may first use collection of keys 118 to further encrypt encrypted message 108, and send encrypted message 108 back to sending machine 106. Then sending machine 106 may use a key from collection of keys 105 to remove the encryption that sending machine 106 added earlier. Next, sending machine 106 may return encrypted message 108 (now having only the encryption added by receiving machine 112) back to receiving machine 112, and receiving machine 112 may use reconstitution algorithm 114 and collection of keys 118 to further decrypt encrypted message 108, thereby reconstituting unencrypted message 102.

Similar to collection of keys 105, one or more keys of collection of keys 118 may be a broad range of sizes, such as 64 bits, 128 bits, 512 bits, 1000 bits, 1024 bits, 4096 bits or larger. In an embodiment, a key K of collection of keys 105 and/or of collection of keys 118 may be divided into segments, which may be of the same size or of different sizes compared to one another. For example, key K may be divided into key halves Kₐ and K_{b}. If K is ABCD1234, then Kₐ may be ABCD and K_{b} is 1234. As another example, if K is 1011 1000 1101 0011 1001 0001 1111 0000, then Kₐ may be 1011 1000 1101 0011 and K_{b} may be 1001 0001 1111 0000.

FIG. 2 shows a block diagram of an algorithm for performing encryption. Algorithm 200 may include one or more instructions 202, one or more operators 204, and transformation portion 206. In other embodiments, algorithm 200 may not have all of the components listed above or may have other components instead of and/or in addition to those listed above.

Algorithm 200 may be an embodiment of encryption algorithm 104 and/or reconstitution algorithm 114. Instructions 202 are steps carried out to encrypt unencrypted message 102 and/or reconstitute encrypted message 108. Instructions 202 may reference operators 204 and/or cause operators 204 to be implemented. For example, in an embodiment, instructions 202 reference one or more of operators 204, and each reference to one of operators 204 may cause that operator to be implemented. In one embodiment, one or more of operators 204 have an inverse. In an embodiment, using operators that have inverses facilitates building algorithm 200 such that it can be inverted, by allowing algorithm 200 to be built from the inverse of those of operators 204 that were used for encrypting unencrypted message 102. In another embodiment, one or more of operators 204 obey the commutative law. In an embodiment, using operators that obey the commutative law facilitates decrypting a message by applying at least some of the decryption operators in different order than the corresponding encryption operations were performed.

In an embodiment, operators 204 have the properties of obeying the associative law, the commutative law, and the identity laws. Obeying the identity law implies the operator operates on a group of elements (e.g., numbers or matrices) in such a manner that one of the elements functions as an identity element. Using operators that obey the commutative law, identity law, inverse law, and associative law facilitates building reconstitution algorithm 114 from the inverse operations of the operations that make up encryption algorithm 104, such that reconstitution algorithm 114 is an inverse of algorithm 104. Additionally, reconstitution algorithm 114 may be the same algorithm as encryption algorithm 104, which may be its own inverse.

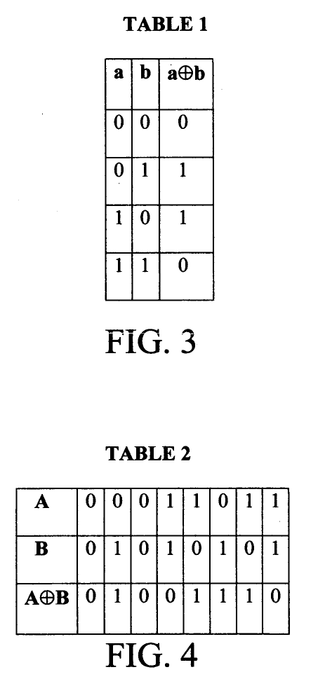

One example of an embodiment of operators 204 is the exclusive-or operator. The exclusive-or operator is represented by the symbol ⊕. The exclusive-or is a binary operator that is defined in TABLE 1, which is discussed further below in conjunction with FIG. 3.

An extension of the exclusive-or ⊕ operator, which will be referred to as the n-dimensional exclusive-or ⊕, is obtained by applying the exclusive-or ⊕ one bit at a time to corresponding bits of two series of bits.

Specifically, suppose A=(a₁, a₂, a₃, . . . , aₙ) and B=(b₁, b₂, b₃, . . . , bₙ), where the symbol n represents a natural number, such that for each i satisfying 1≦i≦n, the variable aᵢ is either 0 or 1 and the variable bᵢ is either 0 or 1. The variables aᵢ and bᵢ are elements of the set of binary elements {0, 1}, and are sometimes called bits. A and B are elements of the set {0, 1}ⁿ, which is the n-fold Cartesian product of the set of binary elements {0, 1}. The set {0, 1}ⁿ will be referred to as an n-dimensional bit space. The n-dimensional exclusive-or ⊕ on the n-dimensional bit space {0, 1}ⁿ is a function ⊕: {0, 1}ⁿ×{0, 1}ⁿ→{0, 1}ⁿ. In other words, the n-dimensional exclusive-or ⊕ is an operator on the n-dimensional bit space {0, 1}ⁿ that maps two elements of the n-dimensional bit space {0, 1}ⁿ to another element of the n-dimensional bit space {0, 1}ⁿ. The binary operator ⊕ on the n-dimensional bit space {0, 1}ⁿ is defined as A⊕B=(a₁⊕b₁, a₂⊕b₂, a₃⊕b₃, . . . , aₙ⊕bₙ), where each expression aᵢ⊕bᵢ is defined by TABLE 1, FIG. 3. The first coordinate of A⊕B may be a₁⊕b₁, and the nth coordinate of A⊕B may be aₙ⊕bₙ. Elements of the n-dimensional bit space {0,1}ⁿ are sometimes called bit strings of length n.

As an example of applying the exclusive-or on the n-dimensional bit space {0, 1}ⁿ, suppose A=00011011 and suppose B=01010101. Applying the n-dimensional exclusive-or, the result of A⊕B is A⊕B=01001110. TABLE 2, FIG. 4 demonstrates how the n-dimensional exclusive-or ⊕ is the exclusive-or applied on a bit-by-bit basis.

To succinctly state some of the laws that hold for the exclusive-or ⊕ on the n-dimensional bit space {0, 1}ⁿ, the symbol Õ is used to denote the bit string consisting of a zero in every coordinate. In other words, the symbol Õ denotes (0, 0, 0, . . . , 0).

The exclusive-or ⊕ when applied on the n-dimensional bit space {0, 1}ⁿ also obeys the commutative law, inverse law, identity law, and associative law. In other words, for any bit two strings A=(a₁, a₂, a₃, . . . , aₙ) and B=(b₁, b₂, b₃, . . . , bₙ), in which for each i, the elements aᵢ and bᵢ lie in the set {0, 1}, the commutative law is

A⊕B=B⊕A.

Similarly, for any three bit strings A=(a₁, a₂, a₃, . . . , aₙ), B=(b₁, b₂, b₃, . . . , bₙ), and C=(c₁, c₂, c₃, . . . , cₙ), in which for each i, the elements aᵢ, bᵢ and cᵢ lie in the set {0, 1}, the associative law is

(A⊕B)⊕C=A⊕(B⊕C).

Further, for any bit string A=(a₁, a₂, a₃, . . . , aₙ), in which for each i, the element aᵢ lie in the set {0, 1}, the inverse law holds, which is

A⊕A=Õ,

and, the identity law holds, which is

A⊕ Õ=Õ ⊕A=A.

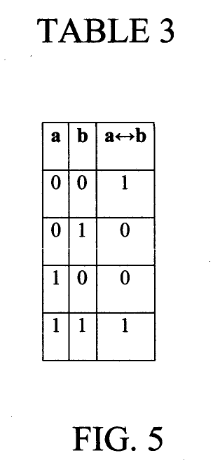

Another example of an embodiment of operators 204 is the biconditional operator. The biconditional operator, may be represented by [symbol] , and operates on {0, 1}ⁿ as follows. The biconditional operator [symbol] on {0, 1}, is defined in TABLE 3, FIG. 5.

Similar to the above definition for the n-dimensional exclusive-or ⊕ on the n-dimensional bit space {0, 1}ⁿ, the n-dimensional biconditional operator [symbol] on the n-dimensional bits pace {0, 1}ⁿ may be defined as [symbol] : {0, 1}ⁿ×{0, 1}ⁿ→{0, 1}ⁿ. In other words, the n-dimensional biconditional operator maps two elements of the n-dimensional bit space {0, 1}ⁿ to another element of the n-dimensional bit space {0, 1}ⁿ. For any two bit strings A=(a₁, a₂, a₃, . . . , aₙ) and B=(b₁, b₂, b₃, . . . , bₙ) that lie in the n-dimensional bit space {0, 1}ⁿ, the n-dimensional biconditional operator [symbol] is defined as

A [symbol] B=(a₁ [symbol] b₁, a₂ [symbol] b₂, a₃ [symbol] b₃, . . . , aₙ [symbol] bₙ).

The symbol 1, lying in {0, 1}ⁿ, may be used to denote the bit string consisting of a 1 in every coordinate. In other words, the symbol \tilde{1}=(1, 1, 1, . . . , 1). With \tilde{1} as the identity element of the n-dimensional biconditional operator ⇄, the n-dimensional biconditional operator [symbol] also obeys the commutative law, inverse law, identity law, and associative law. In other words, for any two bit strings A=(a₁, a₂, a₃, . . . , aₙ) and B=(b₁, b₂, b₃, . . . , bₙ), where for each i, the elements a_{i,} and bᵢ lie in the set {0, 1}, the commutative law holds for the biconditional operator, which is

A [symbol] B=B [symbol] A.

For any three bit strings A=(a₁, a₂, a₃, . . . , aₙ), B=(b₁, b₂, b₃, . . . , bₙ), and C=(c₁, c₂, c₃, . . . , cₙ), where for each i, the elements aᵢ, bᵢ and cᵢ lie in {0, 1}, the associative law holds, which is

(A [symbol] B) [symbol] C=A [symbol] (B [symbol] C).

Similarly, for any bit string A=(a₁, a₂, a₃, . . . , aₙ), where for each i, the element aᵢ lies in the set {0, 1}, the Inverse law holds, which is

A [symbol] A=\tilde{1},

and the identity law holds, which is

A [symbol] \tilde{1}=\tilde{1} [symbol] A=A.

A string of bits may be used to open and/or close a lock that is opened by at least encrypting and/or decrypting information, respectively. In this specification, the term “lock” and “encryption” are used interchangeably except where indicated otherwise. In the n-dimensional exclusive-or ⊕ example and the n-dimensional biconditional operator [symbol] example, the commutative, associative, inverse, and identity laws enable one or more parties, each holding their own bit strng(s) (e.g., lock(s)), to apply encryption operations in one order and decryption operations in another order and/or to change the order in which a combination of encryption and decryption operations are performed without altering the resulting reconstituted message as long as a corresponding decryption (e.g., an inverse) operation was applied for each encryption operation that was applied.

The exclusive-or and the biconditional operators are just two examples of operators that may open and close locks based on a bit string. Any other operator having the commutative, associative, inverse, and identify law may open or close locks based on a bit string. Additionally, other operators that do not necessarily satisfy these laws may also be used to open and/or close locks based on a bit string or another set of characters.

Other operators may also be included within operators 204. The symbol “·” will be used to represent an arbitrary operator. The operator· is generic to the exclusive-or operator, the biconditional operator, and all other operators. Other examples of operators that may be included in operators 204 is an operator· on an n-dimensional bit space {0,1}ⁿ. In other words, the operator· may be an arbitrary combination of biconditional and exclusive-or operators (which operate on bits). For example, ·= [symbol] , [symbol] ,⊕, [symbol] ,⊕, [symbol] , [symbol] ,⊕,⊕,⊕,⊕, [symbol] ,⊕, [symbol] , [symbol] ), wherein n=15.

A nonempty set G is said to be a group if there is a binary operator· on G such that the four properties always hold:
(i) Closure Law: For any elements a, b in G, then a·b lies in G.
(ii) Associative Law: For any elements a, b, c in G, then (a·b)·c=a·(b·c)
(iii) Existence of an Identity Element: There exists an element e in G such that a·e=e·a=a for every element a in G.
(iv) Every element has an inverse element: For any element a in G, there exists an element d in G such that a·d=d·a=e. The element d is called the inverse of a in G. The inverse of a is often written as a⁻¹.
   A commutative group G also satisfies the commutative law: For any elements a, b in G, then a·b=b·a.

Operators that induce a commutative group of transformations enable a lock to be opened at a later time even if there are other locks on the message. The operators formed from combinations of the biconditional and exclusive-or operators induce a commutative group of transformations where the inverse of transformation·K equals transformation·K. As a specific example of decrypting a message by reapplying the encryption transformation a second time, let M=0110 1011, let ·=(⊕,⊕,⊕,⊕, [symbol] , [symbol] , [symbol] , [symbol] ) and let K=0011 1100. Sending machine 106 transmits encrypted message M·K=0101 1000 to receiving machine 112. Receiving machine 112 receives M·K=0101 1000, and computes (M·K)·K, which equals M.

Additionally, although the above operators included within operators 204, act on bits or bit strings, operators may be used that operate on sets of base 10, octal, hexadecimal, or base n numbers, where n can be any number. Similarly, operators that operate on other characters, letters, and/or symbols may also be used.

Transformation portion 206 is a portion of code and/or a portion of hardware that transforms a message into a different representation. Transformation portion 206 may be used for encrypting a message. Transformation portion 206 may be an algorithm that produces a transformation or may be a software interface to hardware that produces a transformation. Transformation portion 206 may use random numbers that are generated by software and/or by hardware. If the random numbers are generated by software, the random number generator may be incorporated within transformation portion 206, or transformation portion 206 may be software and/or hardware that uses random numbers generated by an external random number generator.

For each key A, which may be a bit string, the symbol A· represents a transformation of the message M to an encrypted message A·(M). In this specification, the transformation·A may be substituted for the transformation A· and vice a versa, wherever either transformation occurs, no matter whether the symbol A is used to represent the key or whether another symbol is used to represent the key. The transformation A· is produced by key and transformation generator 107 and/or transformation portion 206. The choice of the symbol A· signifies a transformation on the space of messages. For example, A· may equal A⊕ or A [symbol] .

For a bit string A, there are numerous transformations besides A [symbol] and A⊕, that may be generated in key and transformation generator 107 and/or may be performed by transformation portion 206, depending on the specific embodiment. For A=(a₁, a₂, a₃, . . . , aₙ) one example of a transformation that an embodiment of transformation portion 206 may perform is S_{A}: {0, 1}ⁿ→{0, 1}ⁿ, which is defined as S_{A}(M)=(m₁⊕a₁, m₂⊕a₂, m₃ [symbol] a₃, . . . , mₙ [symbol] aₙ), where the message M=(m₁, m₂, . . . , mₙ). Another example of a transformation that an embodiment of transformation portion 206 may perform is T_{A}: {0, 1}ⁿ→{0, 1}ⁿ, which is defined as T_{A}(M)=(m₁ [symbol] a₁, m₂⊕a₂, m₃⊕a₃, . . . , mₙ⊕aₙ). For the bit string A, there are numerous other transformations (that transformation algorithm 206 may perform), which may be formed creating permutations of sequences of any number of operators. In a similar way, for a different bit string B=(b₁, b₂, b₃, . . . , bₙ) and for any other bit string, there are numerous transformations besides B [symbol] and B⊕.

There are numerous bit strings of length n that may be used to form a transformation that is performed by transformation portion 206. For example, when n=32, there are 2³²=4,294,967,296 different possible bit strings of length 32, and when n=128, there are 2¹²⁸ different possible bit strings of length 128. Any of the possible bit strings may be used by transformation portion 206 to form a transformation.

The transformations of transformation portion 206 may be composed of several transformations in which each transformation is performed on the result of another transformation, such as B⊕(A⊕(M)) or B⊕(A [symbol] M)). Since there are numerous transformations, the symbol S will be used to denote a transformation of a message M. The transformation of the message M may be written as S(M). Suppose T is another transformation. The transformation of M by S, followed by the transformation T, may be written as T∘S(M). The symbol ∘ represents the composition of two transformations, by taking two transformations S and T, and creating a new transformation T∘S. The identity transformation, denoted as Ī, maps any message M to itself. In this function notation the identity transformation operating on message M may be written as, Ī(M)=M. In other words, for any transformation T, then T∘Ī=Ī∘T=T; this is the identity law for transformations.

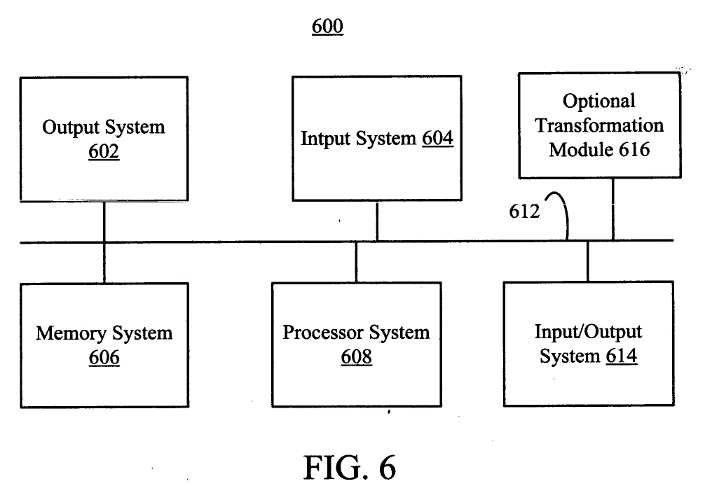

A transformation T has an inverse transformation, denoted as T¹, if T¹∘T=T∘T¹=Ī, which is called the inverse law. Two transformations S and T obey the commutative law if T∘S=S∘T. Finally, the transformations R, S, and T obey the associative law if R∘(S∘T)=(R∘S)∘T). A set of transformations may be said to be closed under a particular operator if application of the operator to two or more elements of the set results in another element of the set. Transformation portion 206 will be discussed further in conjunction with transformation module 616 of FIG. 6.

FIG. 3 shows TABLE 1, which is a truth table for the exclusive-or operator. FIG. 3 shows TABLE 1, which includes columns a, b, a⊕b, and b⊕a. Column a shows possible values for bit a. Column b shows possible values for bit b. Column a⊕b shows the result of applying the exclusive-or operator to bits a and b when bit a has the value shown in column a and bit b has the value shown for bit b. Each row of TABLE 1 represents a different possible combination of values of bits a and b. Since there are four possible combinations of values for bits a and b there are four rows. TABLE 1 shows that whenever bits a and b have the same value, the quantity a⊕b has the value 0, and whenever bits a and b have different values, the quantity a⊕b has the value 1. TABLE 1 also shows that a⊕b and b⊕a always have the same value, and consequently the exclusive-or operator is commutative.

FIG. 4 shows TABLE 2, which shows an example of a n-dimensional exclusive-or ⊕, which is formed by a bitwise application of the exclusive-or operator. TABLE 2 has rows A, B, and A⊕B. Row A shows the value of each bit that constitutes message A. Row B shows each bit that constitutes message B. Row A⊕B shows each bit value of the message A⊕B. Corresponding bits of message A, message B, and message A⊕B are located in the same column. The value of any given bit of A⊕B, which is located in a particular column of TABLE 2, is computed by taking the exclusive-or of the corresponding bit of message A and the corresponding bit of message B (which share the same column as the bit of A⊕B being computed).

FIG. 5 shows TABLE 3, which is a truth table for the biconditional operator. TABLE 3 includes columns a, b and a [symbol] b. Column a shows possible values for bit a. Column b shows possible values for bit b. Column a [symbol] b shows the result of applying the biconditional operator to bits a and b when bit a has the value shown in column a and bit b has the value shown for bit b. Each row of TABLE 3 represents a different possible combination of values of bits a and b. Since there are four possible combinations of values for bits a and b there are four rows. TABLE 3 shows that whenever bits a and b have the same value, the quantity a [symbol] b has the value 1, and whenever bits a and b have different values, the quantity a [symbol] b has the value 0. Thus, the value of the quantity a [symbol] b may also be obtained by taking the complement of the value of the quantity a⊕b. In other words, for a given set of values of bits a and b, if a [symbol] b has the value 1, then a⊕b has the value 0. Similarly, for a given set of values of bits a and b, if a [symbol] b has the value 0, then a⊕b has the value 1.

FIG. 6 shows a block diagram of a machine 600, which may be an embodiment of sending machine 106 and/or receiving machine 112. Machine 600 may include output system 602, input system 604, memory system 606, processor system 608, communications system 612, input/output device 614, and optional transformation module 616. In other embodiments, machine 600 may not have all of the components listed above, or may have other components in addition to and/or instead of those listed above.

Output system 602 may include any one of, some of, any combination of, or all of a monitor system, a handheld display system, a printer system, a speaker system, a connection or interface system to a sound system, an interface system to peripheral devices and/or a connection and/or interface system to a computer system, an intranet, and/or the Internet, for example.

Input system 604 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, Local Area Network (LAN), Wide Area Network (WAN) and/or the Internet (e.g., IrDA, USB), for example.

Memory system 606 may include, for example, any one of, some of, any combination of, or all of a long term storage system, such as a hard drive; a short term storage system, such as random access memory; a removable storage system, such as a floppy drive or a removable drive; and/or flash memory. Memory system 606 may include one or more machine-readable mediums that may store a variety of different types of information.

Processor system 608 may include any one of, some of, any combination of, or all of multiple parallel processors, a single processor, a system of processors having one or more central processors and/or one or more specialized processors dedicated to specific tasks. Communications system 612 communicatively links output system 602, input system 604, memory system 606, processor system 608, and/or input/output system 614 to each other. Communications system 612 may include any one of, some of, any combination of, or all of electrical cables, fiber optic cables, and/or a transmitter for sending signals through air or water (e.g. wireless communications), or the like. Some examples of a transmitter for sending signals through air and/or water include systems for transmitting electromagnetic waves such as infrared and/or radio waves and/or systems for sending sound waves.

Input/output system 614 may include devices that have a dual function as input and output devices. For example, input/output system 614 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 614 is optional, and may be used in addition to or in place of output system 602 and/or input system 604.

Transformation module 616 produces the transformation used by transformation portion 206 of algorithm 200 in embodiments in which transformation portion 206 uses results of a hardware produced transformation. A property of a transformation is its unpredictability or randomness. Transformation module 616 may include a random number generator or random event generator for producing the element of randomness used by key and transformation generator 107 and/or transformation portion 206 and/or transformation module 616 to produce the resulting transformation. In this specification, the term “perfect secrecy” refers to a message for which the number of possible transformations is at least as large as the number of possible messages. In other words, perfect secrecy is obtained when the a posteriori probability of a finding a particular encrypted message representing various messages is the same as the a priori probability of guessing the same messages before the interception. In other words, possession of the encrypted message does not increase the probability of guessing what the unencrypted message is.

There are numerous hardware, software, and hardware/software hybrids that may be used for transformation module 616, transformation portion 206 and/or the combination of transformation portion 206 and transformation module 616 that are at least in theory capable of generating transformations that have perfect secrecy. Transformation module 616 may include a random event generator. In this specification, a random event generator is generic to a random number generator, because the generation of a number is an event, and if the value of the number is random then the event is a random event. In one embodiment, transformation module 616 may include a hardware device that places two Metal Insulator Semiconduction Capacitors (MISC) in close proximity. The random bit may be determined by the difference in charge between the two MISCs (see Agnew, G. B. (1988) “Random Source for Cryptographic Systems,” Advances in Cryptology—EUROCRYPT 1987 Proceedings, Springer-Verlag, pp. 77-81, which is incorporated herein by reference).

In another embodiment, transformation module 616 may include one or more Application Specific Integrated Circuit (ASIC) chips that are designed for generating random bits. In an embodiment, transformation module 616 may include a Multiple Lock Cryptography (MLC) that is integrated in hardware within a random bit ASIC chip.

Although in FIG. 6 transformation module 616 is a separate unit from memory system 606, transformation module 616 may be a portion of code stored within memory system 606 or may be integrated within processor system 608. Transformation module 616 may include an ASIC chip having at least software within which a MLC is integrated, providing random bit strings.

In one embodiment, transformation module 616 includes a hardware random number generator that uses thermal noise inside the processor or another chip to produce random circuit transitions (e.g., transitions between different states of the circuit, which may be based on different states of one or more transistors or other circuit component). A software driver (which may be included within transformation portion 206) can use the thermal noise to generate random bit streams to security applications. For example, a software driver (e.g., transformation portion 206) may aggregate the transitions in the states of the circuit and assemble the transitions into a random key of any desired length, which may be used for security applications. An example of a random number generator based on thermal noise is Intel's 820 chipset, which may be included within, or may be, transformation module 616.

In another embodiment, key and transformation generator 107 and/or transformation portion 206 and/or transformation module 616 collects hardware statistical data associated with one or more chips of a computer. The statistical data is then used to produce unbiased random bit strings. For example, PCQNG 2.0 Windows product and J1000KU made by ComScire may be included within key and transformation generator 107 and/or transformation portion 206 and/or transformation module 616, and used to produce a random bit stream.

In another embodiment, transformation module 616 uses quantum mechanical properties of a physical system to generate randomized bit values. Using quantum processes to generate random bit values may be accomplished in many different ways. For example, the quantum mechanical properties of silicon may be used to create a random number generator. As an example of using the quantum mechanical properties of silicon, Intel's Celeron chip may be included within transformation module 616, which provides a hardware random number generator using thermal noise generated by the quantum mechanical properties of silicon.

In another embodiment, transformation module 616 may include a quantum random number generator that uses quantum optics to generate random bits. For example, photons are sent one photon at a time (or in another manner in which individual photons may be tagged and/or tracked) to a semi-transparent mirror. If the photon is reflected, then the next bit is set to a first value. In contrast, if the photon is transmitted, then the next bit is set to a second value. Quantum number generators using quantum optics are available from Quantis.

In another embodiment, transformation module 616 may include one or more proteins that flip between two or more conformations, which can be used to generate random numbers. For example, next bit value may be assigned based on which conformation the protein is at a given interval of time or based on the relative length of time the protein is in one conformation versus another conformation. As an example, transformation module 616 may include ion-selective proteins, sometimes called sodium channels and potassium channels, spanning a cell membrane, which flip between a closed and an open conformation.

In another embodiment, key and transformation generator 107 and/or transformation portion 206 and/or transformation module 616 may include tables of random numbers, such as the RAND tables, generated by the RAND Corporation. Using an appropriate indexing system, tables of random numbers, such as the RAND tables, enable transformation portion 206 and/or transformation module 616 to generate random numbers.

In another embodiment, key and transformation generator 107 and/or transformation portion 206 and/or transformation module 616 may periodically and/or randomly change the cryptographic method being used. In an embodiment, transformation portion 206 and/or transformation module 616 of sending machine 106 and of receiving machine 112 may or may not inform one another of the type of cryptographic method the other party is using. Each party also may or may not know when the other party decides to change the key in use or change the cryptographic method in use, while the message is being transmitted.

There are numerous other ways of changing the encryption method. For example, for each message segment, the transformation applied to encrypt the message segment may be changed. As another example, the sender may use 128-bit DES to encrypt bit strings for the first half of a message sent and then change the 128-bit key used in DES after transmitting every 900 bytes of the message. For the second half of the message, the sender may use a key that is 256-bit AES to generate bit strings. The receiver may use 256-bit AES to generate bit strings for the first third of the message received, and then switch to 256-bit Non-Autonomous Dynamical Orbit Cryptography (NADO) for generating bit strings for the last two thirds of the message received (see U.S. patent, application Ser. No. 10/693,053, Publication No. US-2004-0228480-A1, cited above). Additionally, the size of the bit strings may be changed and the times at which the encryption method is changed may be changed.

In another embodiment, key and transformation generator 107 and/or transformation portion 206 and/or transformation module 616 may implement a non-autonomous dynamical system. Specifically, an iterative autonomous dynamical system is created by a function f: X→X, which operates on an element of the set X and outputs another element of the set X. An initial element is chosen. The elements x of the set X may be a collection of coordinates, such as points. In the provisional application, Ser. No. 60/679,169, the word “point” is used to refer to any type of element (not just points). In this specification, the term “iteration” is used to refer to a process that is repeated multiple times, each time being applied to the results of the last application of the process. The iteration of f on x creates a sequence of points, [x, f(x), f∘f(x), f∘f∘f(x), . . . ]. This sequence of elements is called the orbit of x with the function f. The initial element [x, f(x), f∘f(x), f∘f∘f(x), . . . ] may be referred to as an orbit element or orbit point if the element is a point. It is also possible to create a sequence of elements using a sequence of functions [f₁, f₂, f₃, f₄, . . . ], rather than a single function. For each number i, the iteration of each function fᵢ on an initial orbit element x creates a sequence of elements, [x, f₁(x), f₂∘f₁(x), f₃∘f₂∘f₁(x), f₄∘f₃∘f₂∘f₁(x), . . . ]. As the system is iterated, if the function applied sometimes changes, then the sequence of elements form an iterative non-autonomous dynamical system (see Fiske, Michael (1996) “Non-autonomous dynamical systems applied to neural computation,” Ph.D. Thesis, Northwestern University, which is incorporated herein by reference).

An iterative autonomous dynamical system is a special case of a non-autonomous dynamical system. If all the fᵢ in the sequence of functions [f₁, f₂, f₃, f₄, . . . ], represent the same function, then this is the definition of an autonomous dynamical system.

The orbit [x, f₁(x), f₂∘f₁(x), f₃∘f₂∘f₁(X), f₄∘f₃∘f₂∘f₁(x), . . . ] can generate an unpredictable sequence of bit values, such as 0's and 1's, in more than one way. One way to choose the bit values is to apply a function to two consecutive elements in the series that makes up the orbit and base the bit values on the relative value of two outputs of the application of the function to different pairs of elements. The function used will be referred to as a two-element-function, because it operates on two elements. The output of the two-element-function will be referred to as the magnitude of the two-element-function. Binary operators are a special case of two-element-functions. An example of a two-element-function that operates on two elements X₁=(x₁₁, x₁₂, . . . x₁ₙ) and X₂=(x₂₁, x₂₂, . . . x₂ₙ) of the set of coordinates of the points of an n dimensional space is the distance d between the points, which is the distance

$$d = \sqrt{{\sum }_{i = 1}^{n} {( {x}_{1 i} - {x}_{2 i} )}^{2}} .$$

There are many other two-element-functions that may be used, such as

$$d = {\sum }_{i = 1}^{n} \vert {x}_{1 i} - {x}_{2 i} \vert , \\ d = \sqrt{{\prod }_{i = 1}^{n} {( {x}_{1 i} - {x}_{2 i} )}^{2}} , \\ and$$

$$d = {\sum }_{i = 1}^{n} ( {x}_{1 i} {x}_{2 i} ) .$$

If the magnitude of the two-element-function operating on the consecutive elements f₁(x) and f₂∘f₁(x) is greater than the magnitude of the two-element-function operating on the elements f₂∘f₁(x), and f₃∘f₂∘f₁(x), then a first value is chosen for the next bit. If the magnitude of the two-element-function operating on the elements f₁(x) and f₂∘f₁(x) is less than the magnitude of the two-element-function operating on the consecutive elements f₂∘f₁(x), and f₃∘f₂∘f₁(x), then the second value is chosen. If the two magnitudes of the two two-element-functions are equal, then neither the first nor the second value is chosen. In general, in this specification when two numbers are said to be equal the two numbers are equal within a tolerance. The tolerance may be determined by the accuracy of the computation being performed and/or the measuring device measuring the numbers. The tolerance may be determined by a customary tolerance to which such computations are performed. For example, when measuring or computing quantities two numbers may be considered equal when they are equal to within two or three significant digits. In another embodiment, two numbers may be considered equal when they are determined to be equal to within the limits of single or double precision computations (depending on the computation being performed).

The next bit value is chosen in a similar manner. Specifically, if the magnitude of the two-element-function operating on two consecutive elements f₂∘f₁(x) and f₃∘f₂∘f₁(x) is greater than the magnitude of the two-element-function operating on the two consecutive elements f₃∘f₂∘f₁(x) and f₄∘f₃∘f₂∘f₁(x), then the first value is chosen. If the magnitude of the two-element-function operating on consecutive elements f₂∘f₁(x) and f₃∘f₂∘f₁(x) is less than the magnitude of the two-element-function operating on consecutive elements f₃∘f₂∘f₁(x) and f₄∘f₃∘f₂∘f₁(x), then second value is chosen. If the magnitudes are equal, neither the first nor the second value is chosen. This process is repeated until enough bit values are chosen to make up the desired key.

In another embodiment, key and transformation generator 107 and/or transformation portion 206 and/or transformation module 616 establish a subset A of X. If the element x lies in A, then a first value is chosen for the next bit. Otherwise, a second value is chosen for the next bit. Continuing this example, if f₁(x) lies in A, then the first value is chosen for a second bit. Otherwise, the second value is chosen for the second bit. Similarly, if f₂∘f₁(x) lies in A, then a first value is chosen for a third bit. Otherwise, the second value is chosen for the third bit. This process is repeated until enough bits are chosen to create a key.

In another embodiment, key and transformation generator 107 and/or transformation portion 206 and/or transformation module 616 use a vector field on a manifold to create a random number generator. A smooth dynamical system is created by a vector field on a manifold (see Spivak, Mike (1979) Differential Geometry, Volume I, Publish or Perish, Inc., which is incorporated herein by reference).

If the function that defines the vector field does not change over time, then it is a smooth autonomous dynamical system. If the function that defines the vector field changes smoothly over time, then it is a smooth non-autonomous dynamical system. In a smooth autonomous dynamical system, one creates a sequence of unpredictable elements (e.g., points) [p₁, p₂, p₃, . . . ], by sampling the coordinates of the trajectory at successive times, such as t₁<t₂<t₃, and so on. An unpredictable sequence of bit values (e.g., 0's and 1's) are chosen based on the magnitudes of two-element-functions applied to elements [p₁, p₂, p₃, . . . ] in a similar way to a discrete dynamical system. If the magnitude of the two-element-function applied to elements p₁ and p₂ is greater than the magnitude of the two-element-function applied to elements p₃ and p₄, then a first value is chosen. If the magnitude of the two-element-function applied to elements p₁ and p₂ is less than the magnitude of the two-element-function applied to elements p₃ and p₄, then a second value is chosen. If the magnitudes are equal, neither the first nor the second value is chosen.

For the next bit value, if the magnitude of the two-element-function applied to elements p₅ and p₆ is greater than the magnitude of the two-element-function applied to elements p₇ and p₈, then a first value is chosen. If the magnitude of the two-element-function applied to elements p₅ and p₆ is less than the magnitude of the two-element-function applied to elements p₇ and p₈, then a second value is chosen. If the magnitudes of the two-element-functions are equal, neither value is chosen. This process is repeated until enough bit values are chosen to form a key.

In another embodiment, key and transformation generator 107 and/or transformation portion 206 and/or transformation module 616 may use a hash function to amalgamate random information generated from one or more sources, including the ones mentioned above, and produce random numbers. Additional sources of random information may come from a standard computer environment, such as keystrokes, mouse commands, the sector number, time of day, and seek latency for every disk operation, actual mouse position, the number of the current scanline on the monitor, input from a microphone, the CPU load, contents of the file allocation tables, kernel tables and other operating system statistics, and the contents of the displayed image on the monitor.

In another embodiment, transformation portion 206 and/or transformation module 616 may use SHA-1, developed by the National Security Agency (NSA) and standardized by National Institute of Standards and Technology (NIST) as the hash function (see National Institute of Standards and Technology, (1995) Secure Hash Standard, FIPS PUB 180-1, Apr. 17, 1995, which is incorporated herein by reference). Other examples of hash functions that may be used are MD5, SHA-512, SHA-256, or SHA-384 (see Schneier, Bruce (1996), APPLIED CRYPTOGRAPHY, John Wiley & Sons, Inc., which is incorporated herein by reference).

In another embodiment, key and transformation generator 107 and/or transformation portion 206 and/or transformation module 616 use devices that generate bit strings based on electromagnetic radiation in the local environment. There are a variety of ways of generating bit strings based on electromagnetic radiation in the local environment. In one embodiment, transformation module 616 includes at least two solar cells, which will be referred to as Bit_0 and Bit_1. At a 1^{st} sampling time, if the voltage of cell Bit_0 is greater than the voltage of Bit_1 then the next random bit is a first value (e.g., 0 or 1). In contrast, if the voltage of cell Bit_1 is greater than the voltage of Bit_0 then the next bit is a second value (e g., 1 or 0, respectively). However, at a 2^{nd} sampling time, if the voltage of cell Bit_0 is greater than the voltage of Bit_1 then the next random bit is the second value (e.g., 1 or 0). In contrast, if the voltage of cell Bit_1 is greater than the voltage of Bit_0 then the next bit is the first value (e.g., 0 or 1, respectively). For the 2^{nd} sample, the criterion of whether to assign the first or second value is reversed with respect to the first sampling in case there is a bias toward one cell having a greater value versus another.

A rule that may be used for the 1^{st}, 3^{rd}, 5^{th} and all odd samples is if the voltage of cell Bit_0 is greater than the voltage of Bit_1 then the next random bit is the first value, while if the voltage of cell Bit_1 is greater than the voltage of Bit_0 then the next bit is the second value. A rule that may be used for the 2^{nd}, 4^{th}, 6^{th} and all even samples is if the voltage of cell Bit_0 is greater than the voltage of Bit_1 then the next random bit is the second value, while if the voltage of cell Bit_1 is greater than the voltage of Bit_0 then the next bit is the first value.

In another embodiment, key and transformation generator 107 and/or transformation portion 206 and/or transformation module 616 may use a Geiger counter to detect certain types of particles, which may be a result of radioactive decay. The time of any given decay is random, and consequently, the interval between two consecutive decays is also random.

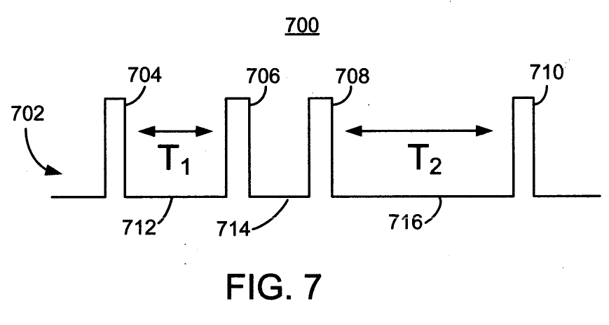

FIG. 7 shows a timing diagram 700 illustrating using the random time intervals of a Geiger counter, which may be included in transformation module 616, to generate the next bit value. Timing diagram 700 includes pulse train 702, which includes pulses 704, 706, 708, and 710, which are separated by time intervals 712, 714, and 716.

In timing diagram 700 of FIG. 7, pulses 704, 706, 708, and 710 correspond to the detection of certain types of particles. For example, pulses 704, 706, 708, and 710 may be caused by a particle entering a tube filled with a type of gas that is at least partially ionized by the particle, thereby creating a current that results in one of pulses 704, 706, 708, and 710. There are many types of Geiger counters, which are sensitive to different types of particles, such as photons and alpha particles, which are often associated with radioactive decay. Time interval 712, having length T₁, is the time elapsed between two consecutive pulses 704 and 706, time interval 714, is the time elapsed between pulses 706 and 708, and time interval 716, having length T₂, is the time elapsed between the next two consecutive pulses 708 and 710. In the provisional application, Ser. No. 60/679,169, the detection of a pulse and/or the pulse itself is referred to as radioactive decay or as the decay of a particle, because the pulses are associated with the detection of particles that are usually associated with radioactive decay. However, a Geiger counter may be used to generate random numbers, as in conjunction with FIG. 7, whether or not the particles detected result from radioactive decay or from some other source as long as the length of the time intervals between detecting particles is random.

In an embodiment, key and transformation generator 107 and/or transformation portion 206 and/or transformation module 616 may determine the 1st random bit, wait until the next pulse occurs, and then measure the length of time interval 712, T₁, between the two pulses 704 and 706. Then wait for a second pair of pulses 708 and 710 and measure the length of interval 716, T₂, between pulses 708 and 710. If T₁=T₂, the next bit is not set to any value. Otherwise, if T₁<T₂, then set the value of the next bit to a first value (e.g., 0 or 1), while if T₁>T₂, set the value of the next bit to a second value (e.g., 1 or 0, respectively). In the provisional application, Ser. No. 60/679,169, setting the value of the next bit is often referred to as generating a bit

To avoid a bias due to the counter or measuring process, the determination of a bit is reversed on the even bits. In particular, a rule that may be used for the 2^{nd}, 4^{th}, 6^{th}, and all even bits is if T₁=T₂, the next bit is not set to any value. Otherwise, if T₁<T₂, then the next bit is set to a first value, while if T₁>T₂, the next bit is set to a second value.

A rule that may be used for the 1^{st}, 3^{rd}, 5^{th}, and all odd bits is if T₁=T₂, do not set the value of any bits. Otherwise, if T₁<T₂, then set the value of the next bit to the second value, while if T₁>T₂, then set the value of the next bit to the first value. In another embodiment, time intervals 712 and 714 could be used for T₁ and T₂, respectively. In another embodiment, random numbers may be generated based on whether the number of particles detected in a given time interval is greater or less than a preset threshold. In several of the above methods of generating random bits, if two quantities are equal, the next bit is not set. However, in another embodiment, the first time the quantities are equal a first of two values is chosen for the next bit and the next time the one of two quantities are equal a second of two values is chosen. Alternatively, another sequence of bit values may be assigned to the next bit when the two quantities are equal. As long as the occurrences of the two quantities being equal are random and as long as there is not a significant bias for the two quantities to be equal (instead of being different), the resulting sequence of bits is expected to be at least substantially random.

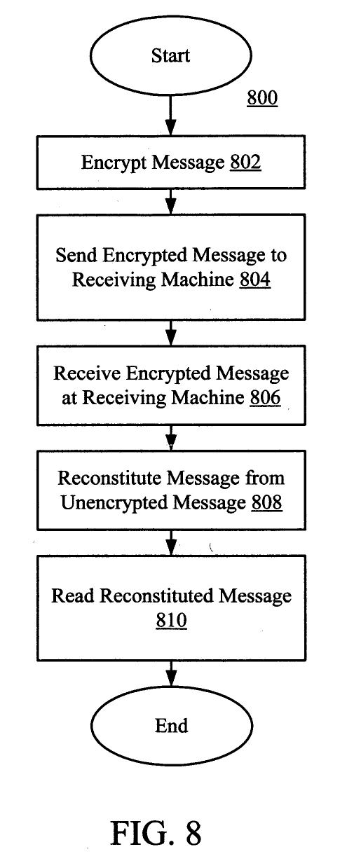

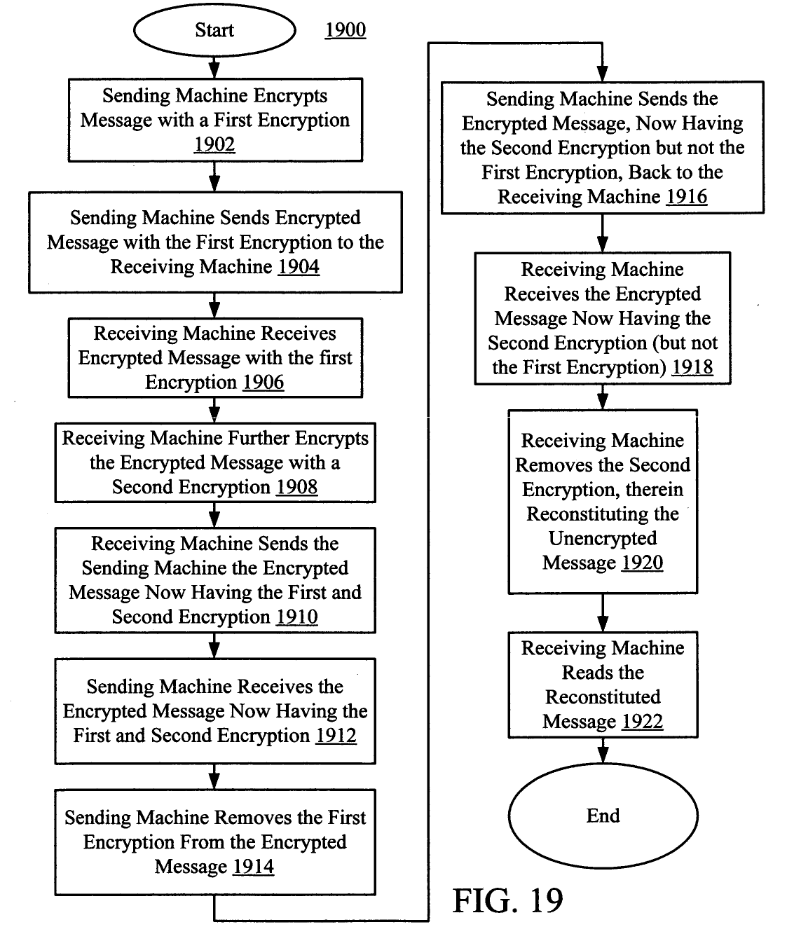

FIG. 8 shows a method 800 for transferring information in which both the sending machine 106 and receiving machine 112 have the same key. Suppose sending machine 106 wants to securely transmit information to receiving machine 112. Sending machine 106 and receiving machine 112 already possess a key K that is thought to be unknown to an outsider. A method that may be used for transmitting key K from sending machine 106 to receiving machine 112 and/or from receiving machine 112 to sending machine 106 is discussed in conjunction with FIG. 19. In the embodiment of FIG. 8, collection of keys 105 and collection of keys 118 are the same key, which may be key K.

In step 802, sending machine 106 encrypts unencrypted message M (e.g., unencrypted message 102) with key K (of collection of keys 105) generated by key and transformation generator 107. For example, sending machine 106 may use encryption algorithm 104 and collection of keys 105 and transformation generator 107 to encrypt unencrypted message 102, by at least computing M·K, thereby forming encrypted message 108. Prior to, or as part of, step 802, unencrypted message 102 may have been generated at message machine 106 or entered into message machine 106 via a keyboard, electronic writing pad, mouse, LAN, WAN, telephone receiver, microphone USB device and/or other storage medium.

In step 804, sending machine 106 transmits encrypted message 108 (e.g., M·K) to receiving machine 112. For example, sending machine 106 transmits, via transmission path 110, encrypted message 108 to receiving machine 112.

In step 806, receiving machine 112 receives encrypted message 108. For example, receiving machine 112 receives M·K. In step 808, since receiving machine 112 knows key K, receiving machine 112 reconstitutes unencrypted message 102, such as by at least computing (M·K)·K, which equals M. Receiving machine 112 may use reconstitution algorithm 114 and collection of keys 118 to reconstitute unencrypted message 102 from encrypted message 108. Reconstitution algorithm 114 may decrypt encrypted message 108 by performing the inverse of the operations performed by encryption algorithm 104. Performing the inverse of the operations performed by encryption algorithm 104 may involve a second application of the same operations performed by encryption algorithm 104, such as by applying the transformation·K a second time. In step 810, receiving machine 112 reads message M. For example receiving machine 112 reads unencrypted message 102.

In step 810, the reconstituted message 116 is read. Step 810 may include performing instructions in reconstituted message 116 and/or outputting the reconstituted message 116, such as by displaying reconstituted message 116 on a display, storing reconstituted message 116 in a file, and/or printing out reconstituted message 116 on paper.

In an embodiment, if method 800 is repeated a new key K is distributed to sending machine 106 and receiving machine 112 (e.g., sending machine 106 sends the new key to receiving machine 112 or receiving machine 112 sends the new key to sending machine 106). In one embodiment, method 1900 is used to send a new key from sending machine 106 to receiving machine 112. Method 1900 is discussed in conjunction with FIG. 19. In another embodiment, the same key K may used for multiple messages. However, changing the key used is expected to be more secure than using the same key.

In an embodiment, the messages and keys sent are of the same length. In another embodiment, the message M that sending machine 106 wants to send to receiving machine 112 may be smaller than key K that is used to encrypt message M. If message M is smaller than key K, message M may be padded with data (e.g., message M may be padded with a string of 0's or other characters) so that the padded message M is the same size as key K.

In another embodiment, the message M, (e.g., unencrypted message 102, which is sent by sending machine 106 to receiving machine 112), may be greater than the length, denoted as L, of the smallest key in collection of keys 105 (e.g., message M may be larger than the largest key of collection of keys 105). For example, sending machine 106 may want to securely send to receiving machine 112 the contents of a CD-ROM, which contains 600 megabytes of data. If message M is longer than L, message M is divided into smaller message segments M₁, M₂, . . . , M_{q}. In an embodiment of method 800, sending machine 106 and receiving machine 112 may share a set of keys K₁, K₂, . . . , K_{q}, that are used for encrypting and sending message segments M₁, M₂, . . . , M_{q}. It may be convenient for each message segment Mⱼ to be the same size as (or smaller than) L. The last message segment, M_{q}, or any message segment that is smaller than its corresponding key, may be padded with zeroes or some other sequence of data, so that the size of the last message segment M_{q} (or any message segment Mᵢ) is the same size as the last key K_{q} (or the corresponding key Kᵢ used to encrypt message segment Mᵢ). In other embodiments, method 800 may not contain all of the steps above, and/or may contain other steps in addition to or instead of those specified above. For example, method 800 may be performed by multiple modules in which each module performs only a part of method 800. In such an embodiment, each module performs a method that only includes some of method 800.

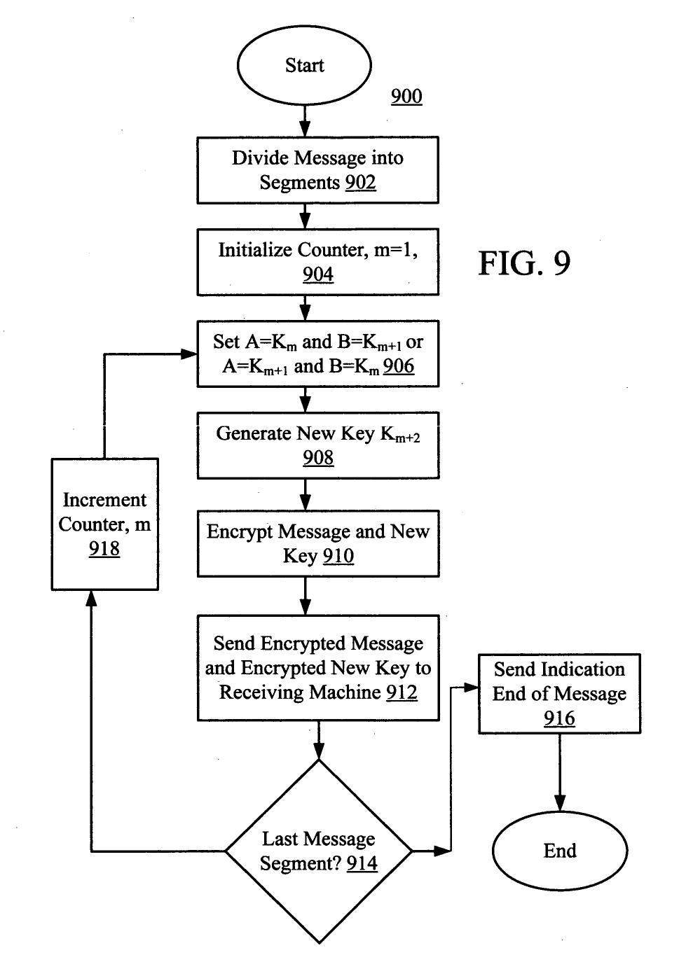

FIG. 9 is a method 900 for encrypting and sending a message that is longer than the size of the smallest key, generated by transformation module 206. In the embodiment of method 900, both sending machine 106 and receiving machine 112 have the same initial collection of keys 105, which is the same as collection of keys 118. A method that may be used for transmitting an initial set of keys, which may be all or some of collection of keys 105, from sending machine 106 to receiving machine 112 and/or for transmitting an initial set of keys, which may be all or some of collection of keys 118, from receiving machine 112 to sending machine 106 is discussed in conjunction with FIG. 19. Method 900 is performed at sending machine 106.

In step 902, message M is divided into message segments, such that M=M₁, M₂, . . . , M_{q}. The index values of the counter, message segments, and keys that appear in this specification are not necessarily the index values that are used, but instead represent where in the sequence of index values each of the actual index values is located. For example, an index value of 1 refers to the first index value used, and the index value of 2 refers to the second index value used. However, the first index value used may be a 0 and the second index value used may be 5. The actual index values used may not even be numerical. Prior to, or as part of, step 902, unencrypted message 102 may have been generated at message machine 106 or entered into message machine 106 via a keyboard, electronic writing pad, mouse, LAN, WAN, telephone receiver, microphone, USB device and/or other storage media. In step 904, sending machine 106 initializes a counter m equal to 1 or the first value of a sequence of index values.

Next in step 906, the sending machine 106 sets first key A equal to key Kₘ (which when m=1 is key K₁), and sets second key B equal to key Kₘ₊₁ (which when m=1 is key K₂). It may be convenient to refer to new key Kₘ₊₁ as a “secret key.” In an alternative embodiment, first key A is set equal to key Kₘ₊₁, and second key B is set equal to key Kₘ. In yet another embodiment, whether first key A is set to key Kₘ₊₁ or key Kₘ, and whether second key B is set to key Kₘ or key Kₘ₊₁ may be dependent upon the current value of index m (e.g., whether m has an even or odd value).

In step 908, sending machine 106 generates a new key Kₘ₊₂ which can be created using transformation portion 206 and/or transformation module 616 as described above. When counter m=1, new key Kₘ₊₂, is K₃.

In step 910 the sending machine 106 encrypts message segment Mₘ and new key Kₘ₊₂ by computing encrypted message segment Mₘ·A and encrypted key Kₘ₊₂·B, respectively. In alternative embodiments, sending machine 106 may encrypt message segment Mₘ and new key Kₘ₊₂ by computing encrypted message segment Mₘ·A and encrypted key Kₘ₊₂·A, encrypted message segment Mₘ·B and encrypted key Kₘ₊₂·B, or encrypted message segment Mₘ·B and encrypted key Kₘ₊₂·A.

In step 912, sending machine 106 transmits encrypted message 108 to receiving machine 112, via transmission path 110. Encrypted message 108 may include encrypted message segment Mₘ·A (or Mₘ·B) and encrypted key Kₘ₊₂·B (or Kₘ₊₂·A). In an alternative embodiment, sending machine 106 only transmits encrypted message segment Mₘ·A (or Mₘ·B), but not the encrypted key. Instead, the encrypted key is received at sending machine 106 from receiving machine 112. For example, sending machine 106 may receive the encrypted key as part of an acknowledgement that encrypted message 108 was received.

Next in step 914, a check is performed to see if the last message segment was sent. The check may be performed by checking whether the current index value m is equal to the last index value q. The check may be performed any time after counter m was initiated. If the last message segment was sent, method 900 proceeds to step 916 where sending machine 106 sends an indication that the end of the message was reached. For example, sending machine 106 may send an End-of-Message symbol, via transmission path 110, to receiving machine 112. Next method 900 terminates.

Returning to step 914, if the last message segment was not yet sent, method 900 proceeds to step 918, where the index is incremented. Next method 900 returns to step 906. However, in an embodiment in which encrypted key Kₘ₊₃·B (or Kₘ₊₃·A) is received from receiving machine 112, then any time prior to returning to step 906 (but after receipt of encrypted key Kₘ₊₃·B− or Kₘ₊₃·A), sending machine 106 uses encryption algorithm 104 and second key B, which is key Kₘ₊₁, (or first key A, which is Kₘ₊₂) to decrypt encrypted key Kₘ₊₃·B (or encrypt key Kₘ₊₃·A) and obtain new key Kₘ₊₃.

As a result of returning to step 906, steps 906, 908, 910, 912, and 914 are repeated. Since the counter is again incremented during the repetition of step 906, the second time through method 900, m=2, first key A=Kₘ₊₁=K₃, second key B=Kₘ=K₂, and new key Kₘ₊₂=K₄ (if whether first key A is set to equal Kₘ or Kₘ₊₁ and whether second key B is set equal to Kₘ₊₁ or Kₘ, respectively, depends on whether m has an odd or even and if on the previously count m=1 first key A=Kₘ=K₁, second key B=Kₘ₊₁=K₂, and new key Kₘ₊₂=K₃). In an alternative embodiment, instead of extracting all of message segments M₁, M₂, . . . , M_{q} from message M at once in step 902, each time counter m is incremented, the current message segment Mₘ is extracted from message M. In other embodiments, method 900 may not contain all of the steps above, and/or may contain other steps in addition to or instead of those specified above. For example, in a secure telephone conversation there may be no last message segment check 914. When the caller hangs up, the call ends and method 900 terminates. As another example, method 900 may be performed by multiple modules in which each module performs only a part of method 900. In such an embodiment, each module performs a method that only includes some of method 900.

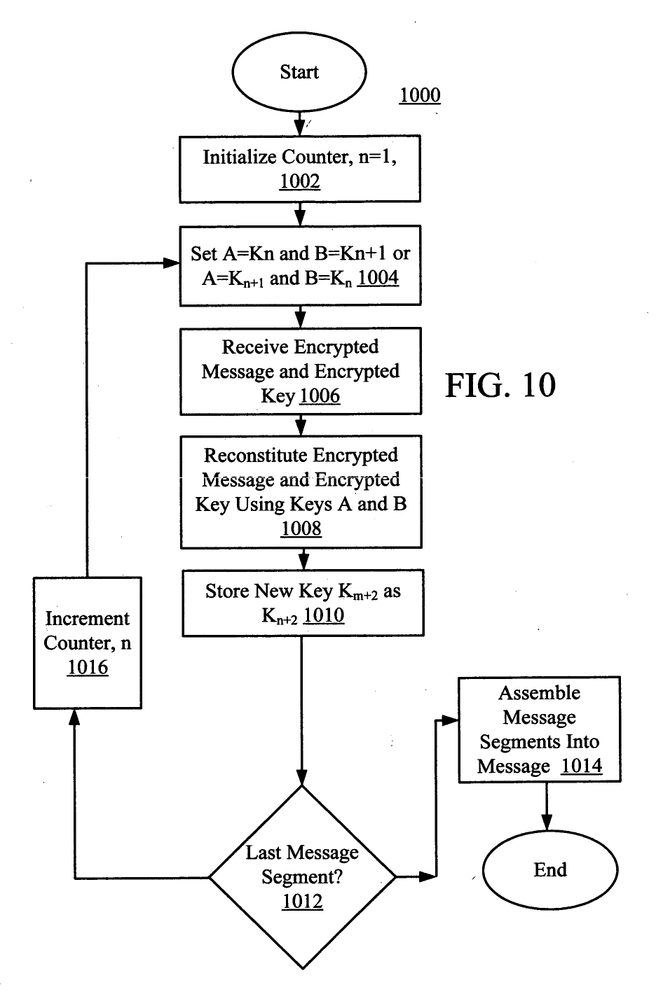

FIG. 10 shows a flowchart of an embodiment of method 1000 for receiving and decrypting, at receiving machine 112, the encrypted message sent as a result of sending machine 106 implementing method 900. In step 1002, receiving machine 112 initializes a counter n equal to 1 or to a first value of a sequence of index values.

In step 1004, receiving machine 112 sets first key A equal to key Kₙ and second key B equal to key Kₙ₊₁. In an alternative embodiment, first key A is set equal to key Kₙ₊₁, and second key B is set equal to key Kₙ. In yet another embodiment, whether first key A is set equal to key Kₙ₊₁ or key Kₙ and whether second key B is set equal to key Kₙ or key Kₙ₊₁ may be dependent upon the current value of index n (e.g., whether n has an even or odd value).

In step 1006, receiving machine 112 waits until encrypted message segment Mₘ·A (or Mₘ·B) and encrypted key Kₘ₊₂·B (or Kₘ₊₂·A) are received. In an alternative embodiment, instead of receiving encrypted key Kₘ₊₂·B (or Kₙ₊₂·A), receiving machine 112 generates key Kₙ₊₂, forms encrypted key Kₙ₊₂·B (or Kₙ₊₂·A), and sends encrypted key Kₙ₊₂·B (or Kₙ₊₂·A) to the sending machine 106.

In step 1008, receiving machine 112 computes (Mₘ·A)·A (or (Mₘ·B)·B) to decrypt encrypted message segment Mₘ·A (or Mₘ·B), thereby obtaining the next unencrypted message segment M_{m.} Receiving machine 112 also computes (Kₘ₊₂·B)·B (or (Kₘ₊₂·A)·A) which equals unencrypted key Kₘ₊₂. Receiving machine 112 is capable of decrypting the encrypted message segment and the encrypted key, because both sending machine 106 and receiving machine 112 possess identical copies of keys A and B. In step 1010, receiving machine 112 stores decrypted key Kₘ₊₂ as key K_{n+2.} (The decrypted key Kₘ₊₂ will become key Kₙ₊₁ the next time—if there is a next time—the receiver executes step 1004 upon incrementing counter n by 1.)

Next, in step 1012, receiving machine 112 checks whether an indication was received that the current message segment is the last message segment. For example, receiving machine 112 may check whether an End-of-Message symbol was received from the sender. In another example, there may be no last message segment check 1014, such as in a secure telephone conversation. When the caller hangs up, the call ends and method 1000 terminates. In another embodiment, receiving machine 112 may have received information indicating the total number of message segments to expect, and receiving machine 112 may therefore check whether counter n corresponds to the last message segment. If the current message segment is the last message segment, then receiving machine 112 proceeds to step 1014 where all the message segments received are assembled (e.g., concatenated) into message M. Alternatively, instead of assembling all the message segments together at the end of method 1000, after each message segment is received, the most recently received message segment is combined with (e.g., concatenated with) the prior received message segments. Step 1014 may include performing instructions in reconstituted message 116 and/or outputting the reconstituted message 116, such as by displaying reconstituted message 116 on a display, storing reconstituted message in a file, and/or printing out reconstituted message 116 on paper. After step 1014, method 1000 terminates.

Returning to step 1012, if the current message segment is not the last message segment, method 1000 proceeds to step 1016, where receiving machine 112 increments the counter n to the next index value in the sequence of index values. Next method 1000 repeats steps 1004, 1006, 1008, and 1010. Upon repeating step 1004, as a result of incrementing counter n and setting first key A=Kₙ₊₁ and second key B=Kₙ, the value of first key A becomes what was the new key prior to incrementing n, and the value of second key B becomes the prior value of second key B (if whether first key A is set to equal Kₙ or Kₙ₊₁ and whether second key B is set equal to Kₙ₊₁ or Kₙ, respectively, depends on whether n has an odd or even and if on the previous count n=1 first key A=Kₙ=K₁, second key B=Kₙ₊₁=K₂, and new key Kₙ₊₂=K₃).

As an example of methods 900 and 1000, Haley wants to send Joanne a message M, starting with message segment M₁. Haley may be a person, a computer, a software program, a phone, another type of electronic device, a mechanical device, or some other kind of machine, such as sending machine 106. Similarly, Joanne may be a person, a computer, a software program, a phone, another type of electronic device, a mechanical device, or some other kind of machine, such as receiving machine 112.

Before any transmission of messages, Haley and Joanne both know keys K₁ and K₂, but it is expected that nobody else knows keys K₁ and K₂. Haley generates new key K₃, which can be used for encrypting a part of the second transmission. Then, for the first transmission, Haley encrypts a first segment M₁, as encrypted message M₁·K₁, and encrypts new key K₃, as encrypted new key K₃·K₂. Haley then sends encrypted message segment and encrypted new key to Joanne. Joanne then decrypts encrypted message segment M₁·K₁ and encrypted new key K₃·K₂. Joanne decrypts encrypted message segment and encrypted new key by at least computing M₁·K₁·K₁ and K₃·K₂·K₂, respectively. Now, Joanne knows message segment M₁ and new key K₃ (in addition to knowing keys K₁ and K₂).

In order to transmit message segment M₂, the second transmission, Haley uses key K₂ to encrypt message M₂, which is computed as M₂·K₂. Next Haley generates new key K₄ for use in the third transmission, and then Haley uses key K₃ to encrypt new key K₄, which is computed as K₄·K₃. Encrypted message segment M₂·K₂ and encrypted new key K₄·K₃ are transmitted from Haley to Joanne. Joanne receives these two encrypted transmissions, and decrypts the two transmissions by computing M₂·K₂·K₂ and K₄·K₃·K₃. Now, as a result of the decryption, Joanne knows message segment M₂ and new key K₄ (in addition to already knowing keys K₂ and K₃).

In order to transmit message segment M₃, Haley uses key K₃ to encrypt message M₃, computed as M₃·K₃. Next Haley generates new key K₅ for use in the fourth transmission, and Haley uses key K₄ to encrypt new key K₅, which is computed as K₅·K₄. Encrypted message segment M₃·K₃ and encrypted new key K₅·K₄ are transmitted from Haley to Joanne. Joanne receives these two encrypted transmissions, and decrypts the two transmissions by computing M₃·K₃·K₃ and K₅·K₄·K₄. Now, as a result of the decryption, Joanne knows message segment M₃ and new key K₅ (in addition to knowing keys K₃ and K₄). This is repeated until Haley transmits the last message segment.

In other embodiments, method 1000 may not contain all of the steps above, and/or may contain other steps in addition to or instead of those specified above. For example, method 1000 may be performed by multiple modules in which each module performs only a part of method 1000. In such an embodiment, each module performs a method that only includes some of method 1000.

In an embodiment of methods 900 and 1000, the message segments are all of the same size, except for possibly the last message segment. In another embodiment, the message segments may be of different sizes as long as each message segment is shorter than the key used to encrypt the message segment. If the message segment is shorter than its encryption key, the message segment can be padded with other data as long as receiving machine 112 has a way of distinguishing the padding from the actual message segment received. Similarly, in one embodiment, the encryption keys are the same size. In another embodiment, the encryption keys used later in method 900 or 1200 may be shorter than the encryption keys that are used earlier in method 900 or 1000.

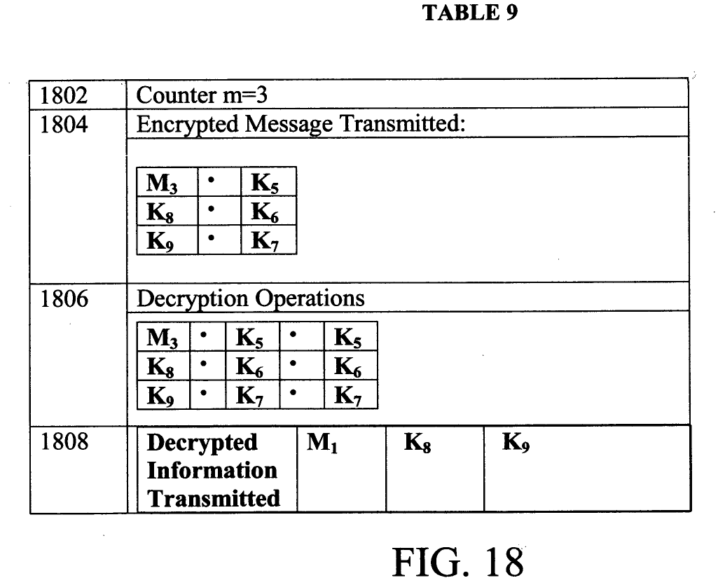

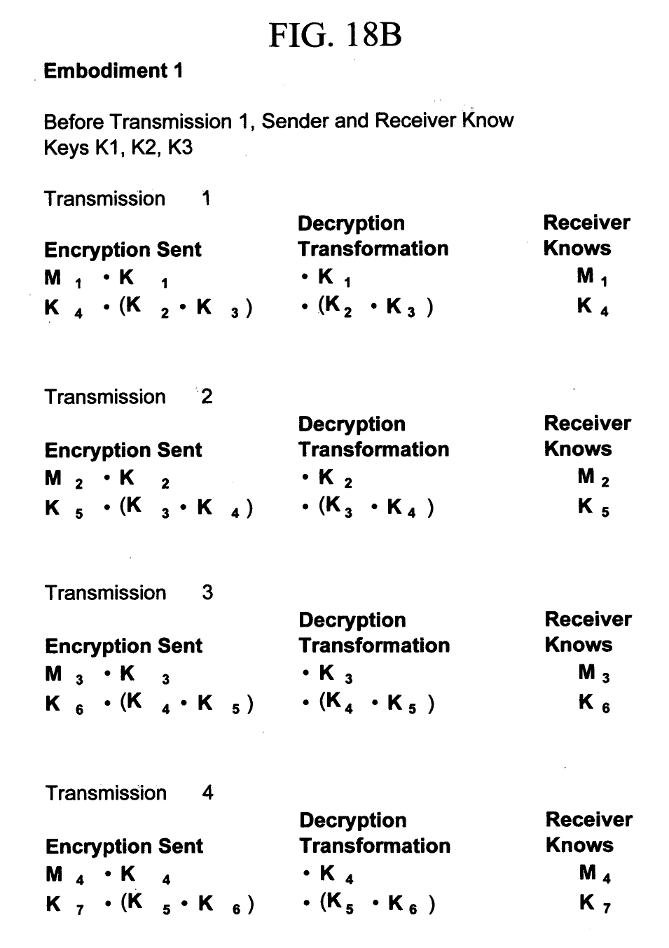

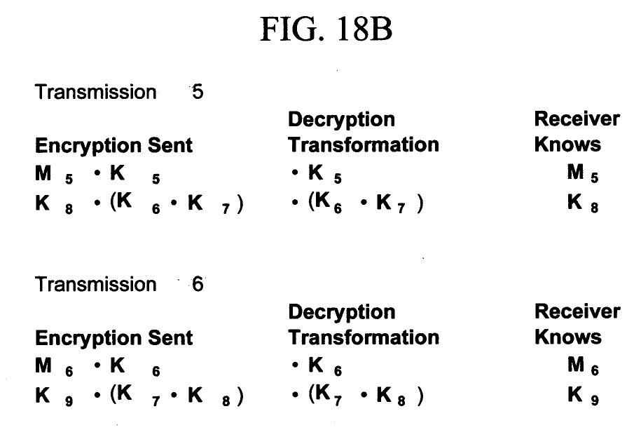

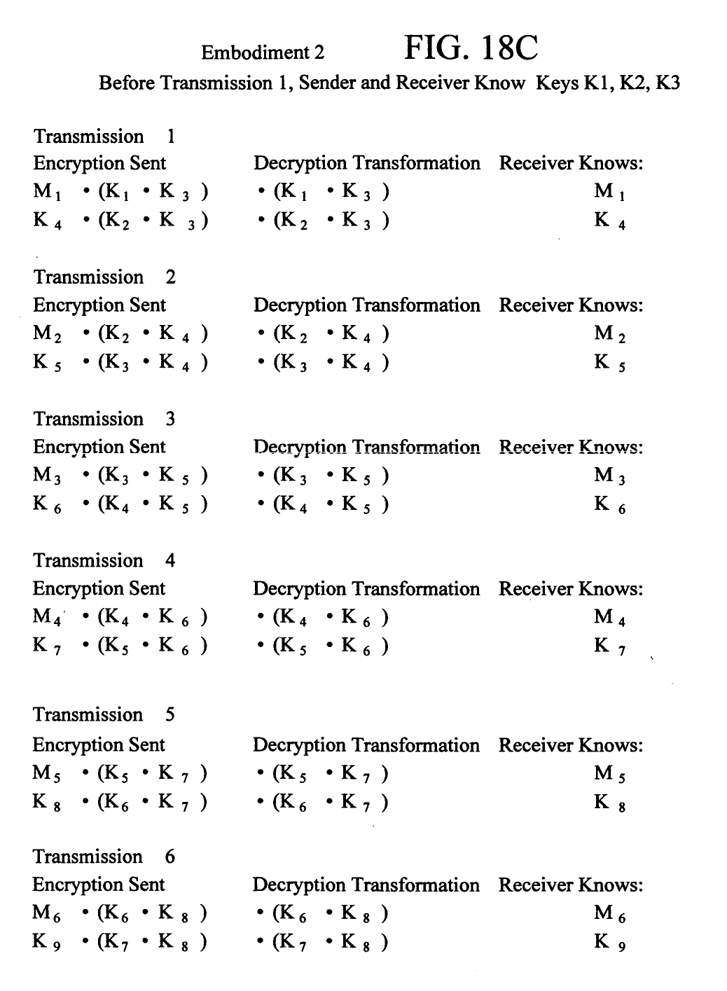

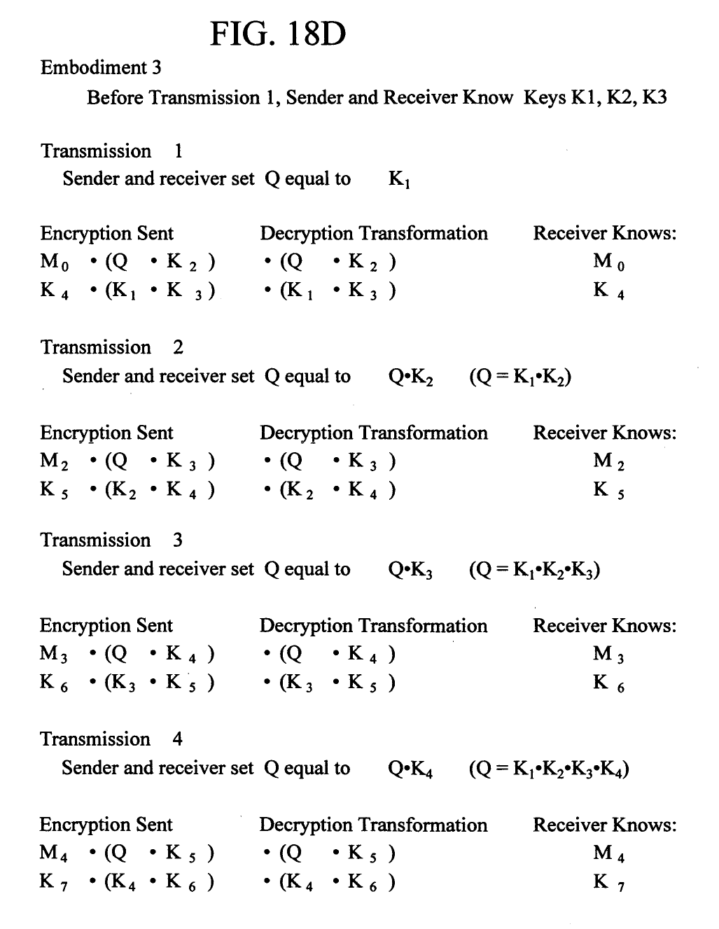

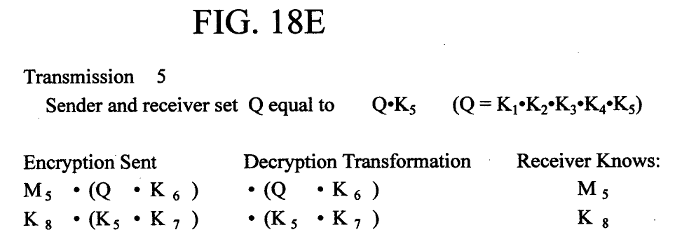

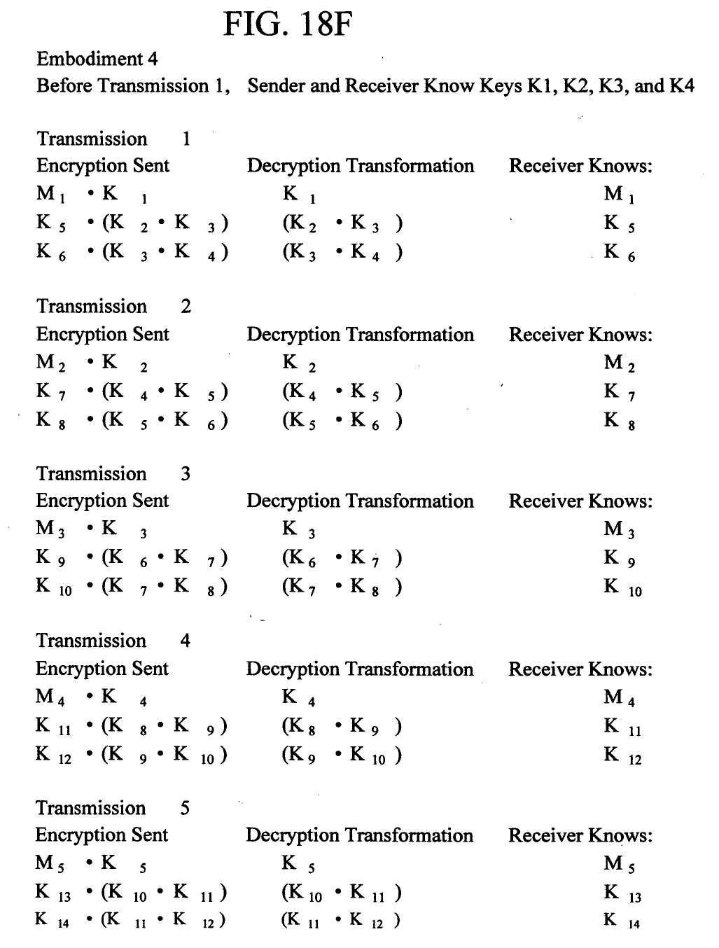

In methods 900 and 1000 only two keys are used. Alternatively, there may be any number of keys. Methods 900 and 1000 may be used for any number of keys, except more keys are used, encrypted, and transmitted. In methods 900 and 1000, in any place where A is used B may be used instead and any place where B is used A may be used to obtain other embodiments. In still other embodiments, at each step, either A or B, or both A and B may be formed with composite keys. Composite keys are discussed in conjunction with FIGS. 18B(1), 18(2), 18C, 18D, 18E and 18F.

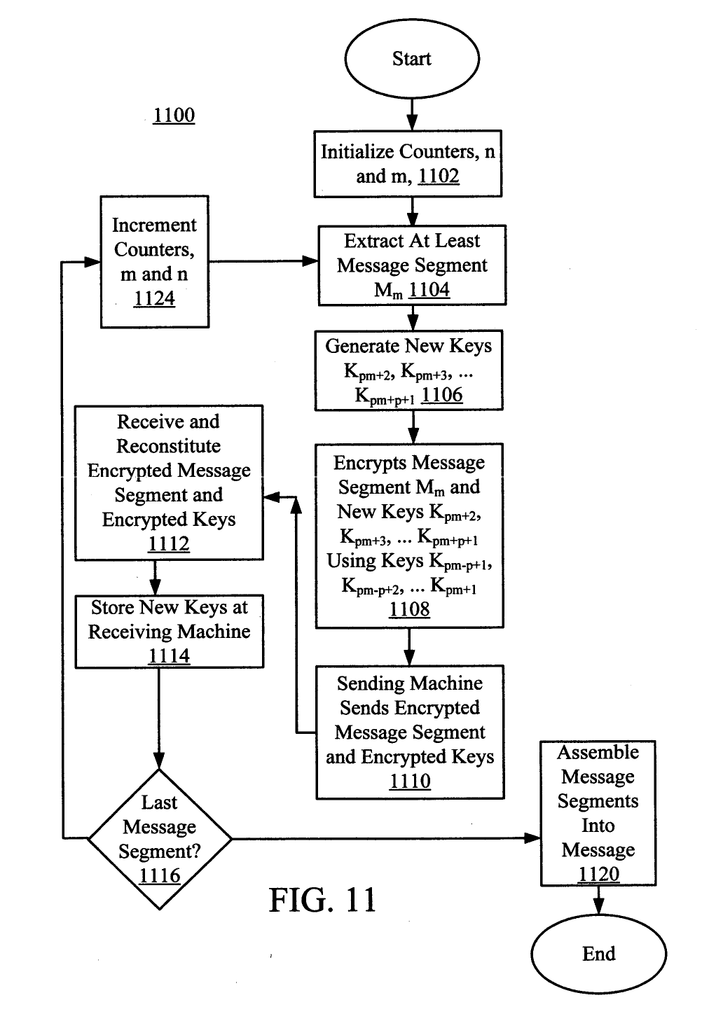

FIG. 11 is a flowchart of an embodiment of method 1100 of transmitting messages while using any number of keys. The combination of methods 900 and 1000 are a specific example of method 1100. Before any transmission of messages, the sending machine 106 and receiving machine 112 are both in possession of keys K₁, K₂, . . . Kₚ₊₁, and it is expected that no one else knows these keys. It may be convenient to refer to keys K₁, K₂, . . . Kₚ₊₁ as the first group of keys and to keys K₂, . . . Kₚ₊₁ as the first set of keys (the combination of key K₁ and the first set of keys makes up the first group of keys). A method that may be used for transmitting the first group of keys from sending machine 106 to receiving machine 112 and/or from receiving machine 112 to sending machine 106 is discussed in conjunction with FIG. 19.

In step 1102, at sending machine 106, counter m is initialized to a first of a sequence of index values, and at receiving machine 112 counter n is initialized to a first of a sequence of index values. In step 1104, a message segment Mₘ from message M is determined. Step 1104 may involve separating from message M each message segment Mₘ with each increment of counter m. In an alternative embodiment, all of the message segments are extracted prior to performing the rest of method 1100. In step 1106, new keys Kₚₘ₊₂, Kₚₘ₊₃, . . . Kₚₘ₊ₚ₊₁ are generated by sending machine 106. It may be convenient to refer to new keys Kₚₘ₊₂, Kₚₘ₊₃₀, . . . Kₚₘ₊ₚ₊₁ as secret keys. It may also be convenient to refer to keys Kₚₘ₊₂, Kₚₘ₊₃, . . . Kₚₘ₊ₚ₊₁ as the m+1^{th} set of keys (e.g., the second set of keys when m=1). Thus, setting m=0, yields the first set of keys K₂, . . . Kₚ₊₁. For example, if p=2, new keys K₂ₘ₊₂ and K₂ₘ₊₃ are generated each time counter m is incremented. The formulas for the indices give chronological order in which the keys were created. For example, if p=4 and m=5, the index formula pm+2=22, which means that key Kₚₘ₊₂, is the 22nd key to be created. Prior to, or as part of, step 1102, unencrypted message 102 may have been generated at message machine 106 or entered into message machine 106 via a keyboard, electronic writing pad, mouse, LAN, WAN, telephone receiver, microphone, and/or USB device or other storage medium.

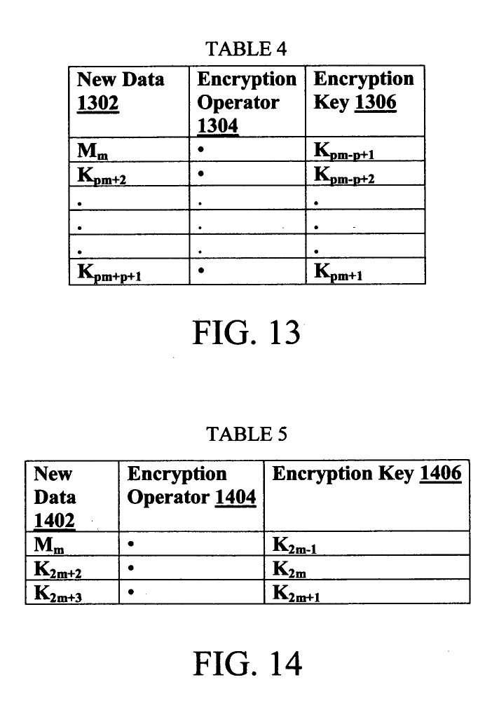

In step 1108, sending machine 106 encrypts message segment Mₘ and new keys Kₚₘ₊₂, Kₚₘ₊₃, . . . Kₚₘ₊ₚ₊₁ using keys Kₚₘ₊ₚ₊₁, Kₚₘ₊ₚ₊₂, . . . Kₚₘ₊₁. It may be convenient to refer to keys Kₚₘ₋ₚ₊₁, Kₚₘ₋ₚ₊₂, . . . Kₚₘ₊₁ as the m^{th} group of keys (e.g., the second group of keys when m=2). In contrast, the m^{th} set of keys is keys Kₚₘ₋ₚ₊₂, Kₚₘ₋ₚ₊₃, . . . Kₚₘ₊₁. Stated differently, the m^{th} group of keys is a combination of key Kₚₘ₋ₚ₊₁ and the m^{th} set of keys. In alternative embodiments, any already known key (that is agreed upon in advance by sending machine 106 and receiving machine 112) may be used instead of key Kₚₘ₋ₚ₊₁ in combination with the m^{th} set of keys to form the m^{th} group of keys. For example, if p=2, message segment Mₘ and new keys K₂ₘ₊₂ and K₂ₘ₊₃ are encrypted using keys K₂ₘ₋₁, K₂ₘ, and K₂ₘ₊₁. The formulas used for encrypting message segment Mₘ and new keys Kₚₘ₊₂, Kₚₘ₊₃, . . . Kₚₘ₊ₚ₊₁ are shown in TABLE 4, FIG. 13, which is discussed below. In alternative embodiments, composite keys may be used to encrypt message segment Mₘ and new keys Kₚₘ₊₂, Kₚₘ₊₃, . . . Kₚₘ₊ₚ₊₁. Composite keys are discussed in conjunction with FIGS. 18B(1), 18B(2), 18C, 18D, 18E and 18F.

In step 1110, sending machine 106 transmits the encrypted message segment and the new encrypted keys (which are the contents of TABLE 4, FIG. 13, or permutations of TABLE 4 discussed below) to the receiving machine 112. In an embodiment, a different permutation of TABLE 4 is sent depending on the value of counter m. There are (p+1)! permutations of TABLE 4, which may be used instead of and/or in conjunction with the set of encryptions in TABLE 4. Specifically, depending on the value of m a different permutation of TABLE 4 may be used. The sequences of permutations that may be used are also discussed in conjunction with TABLE 4.

An example of the encrypted key and encrypted message segment when p=2 is shown in TABLE 5, FIG. 14, which is also discussed below. Specifically, sending machine 106 uses key K₂ₘ₋₁ to encrypt message Mₘ, computed as Mₘ·K₂ₘ₋₁, sending machine 106 uses key K₂ₘ to encrypt key K₂ₘ₊₂, computed as K₂ₘ₊₂·K₂ₘ, and sending machine 106 uses key K₂ₘ₊₁ to encrypt key K₂ₘ₊₃, computed as K₂ₘ₊₃·K₂ₘ₊₁. In an embodiment, only when m is odd (or even) sending machine 106 uses key K₂ₘ₋₁ to encrypt message Mₘ, computed as Mₘ·K₂ₘ₋₁, sending machine 106 uses key K₂ₘ to encrypt key K₂ₘ₊₂, computed as K₂ₘ₊₂·K₂ₘ, and sending machine 106 uses key K₂ₘ₊₁ to encrypt key K₂ₘ₊₃, computed as K₂ₘ₊₃·K₂ₘ₊₁, while in contrast, when m is even (or odd) sending machine 106 uses key K₂ₘ to encrypt message Mₘ, computed as Mₘ·K₂ₘ, sending machine 106 uses key K₂ₘ₊₁ to encrypt key K₂ₘ₊₂, computed as K₂ₘ₊₂·K₂ₘ₊₁, and sending machine 106 uses key K₂ₘ₋₁ to encrypt key K₂ₘ₊₃, computed as K₂ₘ₊₃·K₂ₘ₋₁. In other embodiments, different ones of keys K₂ₘ₋₁, K₂ₘ, K₂ₘ₊₁ or composite keys may be used to encrypt a particular one of Mₘ, K₂ₘ₊₂, K₂ₘ₊₃. Composite keys are discussed in conjunction with FIGS. 18B(1), 18B(2), 18C, 18D, 18E and 18F.

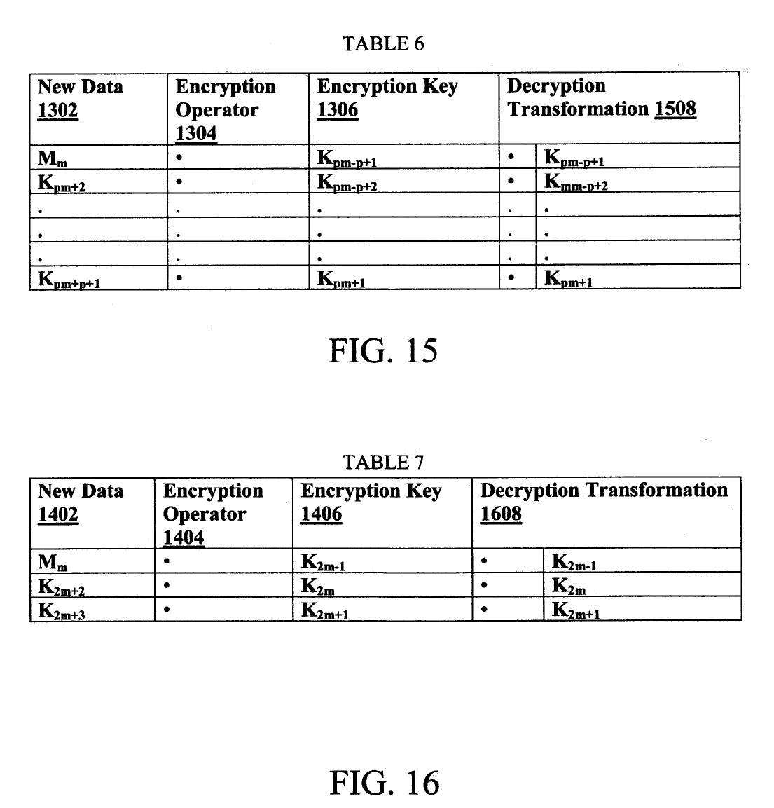

In step 1112, receiving machine 112 receives and decrypts the contents of TABLE 4 or a permutation of TABLE 4 by performing the operations in TABLE 6, FIG. 15 or a permutation of TABLE 6 that corresponds to the current permutation of TABLE 4. An example of the operations of TABLE 6 when p=2 is shown in TABLE 7, FIG. 16, which is discussed, below. Specifically, in TABLE 7, receiving machine 112 uses key K₂ₘ₋₁ to reconstitutes the message Mₘ, receiving machine 112 uses key K₂ₘ to reconstitute the new key K₂ₘ₊₂, and receiving machine 112 uses key K₂ₘ₊₁ to reconstitute new key K₂ₘ₊₃. TABLE 7 may be the computations that are performed when m is an even (or odd) number. In contrast, when m is an odd (or even) number, receiving machine 112 uses key K₂ₘ to reconstitutes the message Mₘ, receiving machine 112 uses key K₂ₘ₊₁ to reconstitute the new key K₂ₘ₊₂, and receiving machine 112 uses key K₂ₘ₋₁ to reconstitute new key K₂ₘ₊₃. As a consequence receiving machine 112 possesses Mₘ, K₂ₘ₊₂, K₂ₘ₊₃. In step 1114, receiving machine 112 stores the new keys.

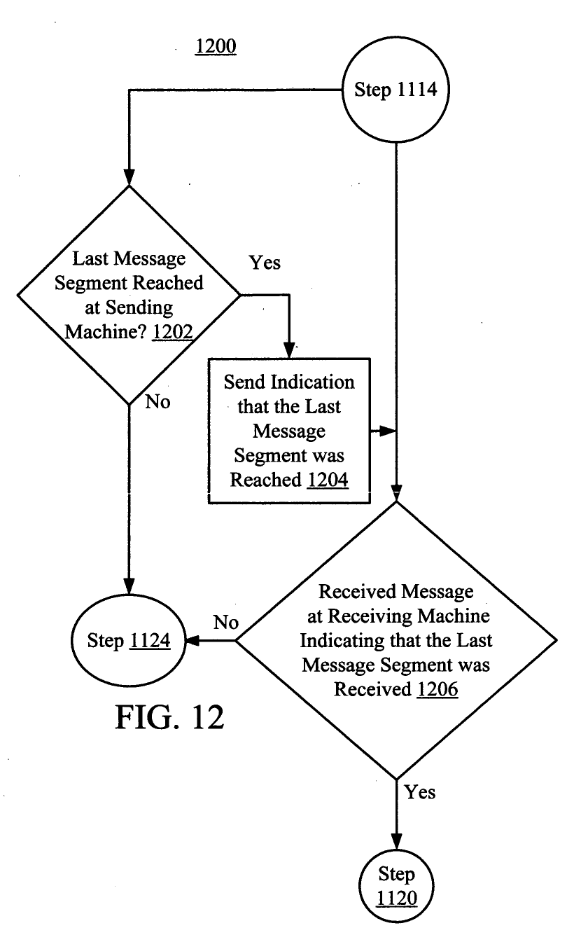

Next, in step 1116, a check is made to determine whether message segment Mₘ is the last segment. The details of step 1116 are discussed in FIG. 12. Next in step 1120, receiving machine 112 assembles the message segments into message M. In an alternative embodiment, as in method 1000 instead of waiting to receive all of the reconstituted message segments, each reconstituted message segment is combined with earlier received message segments as the encrypted message segments are reconstituted. Step 1120 may include performing instructions in reconstituted message 116 and/or outputting the reconstituted message 116, such as by displaying reconstituted message 116 on a display, storing reconstituted message 116 in a file, and/or printing out reconstituted message 116 on paper.

Returning to step 1116, if message segment Mₘ is not the last message segment, counters m and n are incremented by one, in step 1124, and method 1100 is repeated. In other embodiments, method 1100 may not contain all of the steps above, and/or may contain other steps in addition to or instead of those specified above. For example, method 1100 may be performed by multiple modules in which each module performs only a part of method 1100. In such an embodiment, each module performs a method that only includes some of method 1100.

The formulas used for labeling the subscripts of the keys may be included in algorithm 200. However, formulas used for labeling the subscripts of the keys have many variations. For example, the formulas may be altered such that the index of the initial key is 0 (instead of 1), is a negative number, or is any other number. As another example, the index values may decrease instead of increase as more keys are generated. As yet another example, the index values may all be multiples of a number such as 2, 3, or any other number.

FIG. 12 shows a flowchart of an embodiment of a method 1200, which implements step 1116 for checking whether the last message segment has been reached. Sending machine 106 enters step 1202 any time after step 1102. In step 1202, sending machine 106 checks if message segment Mₘ is the last message segment. For example, step 1202 may check whether index m is the same as the expected last index value. If a determination is made that message segment Mₘ is the last message segment, then method 1200 proceeds to step 1204 where a message is sent to receiving machine 112 that the end of the message was reached. Step 1204 may be performed any time after step 1102. Next sending machine 106 terminates the portion of method 1100 that is implemented by sending machine 106. Returning to step 1202, if the last message segment has not been reached then sending machine 106 proceeds to step 1124.

Meanwhile, starting any time after incrementing or initializing index n, receiving machine 112 proceeds to step 1206, and checks whether a message was received from sending machine 106 indicating that the end of the message was reached. If the last message segment was reached, then after performing step 1112, receiving machine 112 proceeds to step 1120. If there is no indication that the last message segment was reached, after step 1112 receiving machine 112 proceeds to step 1124 and increments index n.

In another embodiment, multiple message segments may be sent simultaneously, each message segment may be encrypted with a different key. In another embodiment, the number of keys sent with each transmission may vary. In another embodiment, one or more of the new keys that are sent from the sender to the receiver are never used, whether or not the current transmission contains the last message segment. In another embodiment, the encrypted message is sent at a time that is different from the time that the encrypted keys are sent. In another embodiment, one or more of the new keys sent from the sending machine 106 to the receiving machine 112 are used to decrypt past message segments or past encrypted keys instead of future encrypted keys. In another embodiment, the new keys sent by the sender are used to decrypt one or more future message segments that are sent after the next transmission. In other embodiments, method 1200 may not contain all of the steps above, and/or may contain other steps in addition to or instead of those specified above. For example, method 1200 may be performed by multiple modules in which each module performs only a part of method 1200. In such an embodiment, each module performs a method that only includes some of method 1200.

Although in methods 800, 900, and 1100, messages are only sent from sending machine 106 to receiving machine 112, in some cases it may be desirable for sending machine 106 and receiving machine 112 to send each other information back and forth. For example, it may be desirable to use sending machine 106 and receiving machine 112 for sending e-mail messages to one another, for having an instant messenger conversation, for having a telephone conversation, or for sending and receiving messages associated with an Internet application. The transmission of information from receiving machine 112 to sending machine 106 is performed according to methods 800, 900, 1000, and 1100 except sending machine 106 and receiving machine 112 reverse roles. Specifically, receiving machine 112 may be the sender of methods 800, 900, and 1100, and sending machine 106 may be the receiver of methods 900, 1000, and 1100. Consequently, in this embodiment, encryption algorithm 104 is capable of reconstituting messages and reconstitution algorithm 116 is capable of encrypting messages.

FIG. 13 shows a TABLE 4 of the transmission a sender sends to a receiver. TABLE 4 includes new data column 1302, encryption operators column 1304, and encryption keys column 1306. In other embodiments, not all of the information in TABLE 4 is transmitted or other information is transmitted instead of and/or in addition to the information in TABLE 4.

New data column 1302 includes the information that the sender would like to send to receiving machine 106, which receiving machine 106 is assumed not to have possession of yet. The new data sent includes the current message segment Mₘ and current new keys Kₚₘ₊₂, Kₚₘ₊₃, . . . Kₚₘ₊ₚ₊₁. New keys Kₚₘ₊₂, Kₚₘ₊₃, . . . Kₚₘ₊ₚ₊₁ may be the new keys generated in step 908 or 1106. Encryption operator column 1304 includes the operators that are used to encrypt the data in new data column 1302. Any combination of operators may be used, as indicated by the use of the generic operator symbol “·” in each row of new data column 1302.

Encryption key column 1306 includes the keys being used to encrypt the data in new data column 1302, which include keys Kₚₘ₋ₚ₊₁, Kₚₘ₋ₚ₊₂, . . . Kₚₘ₊₁. A given operator of operator column 1304 and a given key of encryption key column 1306 that share the same row form a transformation used to encrypt the data in new data column 1302 in that row. Each row of TABLE 4 is either an encrypted key or an encrypted message segment, which include encrypted message segment Mₘ·Kₚₘ₋ₚ₊₁ and encrypted new keys Kₚₘ₊₂·Kₚₘ₋ₚ₊₂ . . . Kₚₘ₊ₙ₊₁·Kₚₘ₊₁, which are also an example of the encryption operations that may be performed as part of step 910 or 1108, the encrypted message segment and encrypted keys transmitted as part of step 912 or 1110, and the encrypted message segment and encrypted keys received as part of step 1006 or 1112.

There are certain sequences of the (p+1)! permutations that are more vulnerable (and others that are less vulnerable) to decryption by an unintended receiver of encrypted message 108. In an embodiment, each of the p keys of a set of keys created at a particular value of m is used to form the group of keys for the next either encrypt another key or the next message segment. Thus, each new key is part of a chain of keys that may terminate either when a key from the chain is used to encrypt a message segment or when the last message segment has been transmitted. Each chain starts at m=1. If a chain does nay have any keys that are ever used for encrypting a message segment, then that chain of keys could be replaced by fake data. The keys of a chain that never encrypt any messages do not contribute to the securing of the message except to the extent that the unintended receiver is confused by keys that have not been used and to the extent that the unintended user wastes time trying to decrypt keys that have no use. In an embodiment, sequences of permutations of TABLE 4 that result in chains of keys that are never used are not allowed. In another embodiment, only one chain or only two chains that are never used for encrypting a message segment is allowed. In another embodiment, only 1% of, only 5% of, or only 10% of the p chains that do not encrypt any message segments are allowed. In another embodiment, method 1900 is used to update the keys and each chain of the previous keys is terminated. Method 1900 is discussed in conjunction with FIG. 19.

If only a small number of chains are used to encrypt the majority of the message segments, another vulnerability is created, because only a small number of the encryptions need to be decrypted in order to decrypt the majority of the message. Having the majority of the message may make it easier to decrypt and/or figure out the remainder of the message. In an embodiment, if there are more message segments than keys in a group, sequences of permutations of TABLE 4 are not allowed that result in the majority of a message being encrypted by 10% fewer chains than there are message segments. In an embodiment, if there are fewer message segments than keys in a group, sequences of permutations of TABLE 4 are not allowed that result in the majority of a message being encrypted by 10% fewer chains than there are keys in a group. In another embodimnt, if there are more message segments than keys in a group, sequences of permutations of TABLE 4 are chosen that result in an equal use of all chains. In an embodiment, each permutation in a sequence of permutations are chosen randomly, if it is expected that the permutation is likely to result in a sequence that has one or more the above mentioned vulnerabilities, the permutation is discarded. In another embodiment, a pattern of permutations is chosen that does not have any of the above vulnerabilities. In an embodiment in which there are more than p+1 message segments in a message and in which the sequence of permutations is chosen according to a pattern, the pattern has at least p+1 permutations (however, there could be as many as (p+1)! permutations. In an embodiment, there may be fewer than p+1 permutations in a sequence of permutations.

FIG. 14 shows a TABLE 5, which is an example of the transmission that a sender may send to a receiver. TABLE 5 includes new data column 1402, encryption operators column 1404, and encryption keys column 1406.

TABLE 5 is an example of TABLE 4 in which p=2. New data column 1402 includes the information that the sending machine 106 would like to send to the receiving machine 112, which the receiver is assumed not to have possession of yet. The new data sent includes the current message segment Mₘ and current new keys K₂ₘ₊₂, and K₂ₘ₊₃. New keys K₂ₘ₊₂ and K₂ₘ₊₃ may be the new keys generated in step 908 or 1106. Encryption operator column 1404 may be the same as encryption operators 1304, which were described above. Encryption key column 1406 includes the keys being used to encrypt the data in new data column 1402, which include keys K₂ₘ₋₁, K₂ₘ, and K₂ₘ₊₁. Each row of TABLE 5 is either an encrypted key or an encrypted message segment, which include encrypted message segment Mₘ·K₂ₘ₋₁ and encrypted new keys K₂ₘ₊₁·K₂ₘ . . . K₂ₘ₊₃·K₂ₘ₊₁, which may also be the encryption operations performed as part of step 910 or 1108, the encrypted message segment and encrypted keys transmitted as part of step 912 or 1110, and the encrypted message segment and encrypted keys received as part of step 1006 or 1112.

FIG. 15 shows a TABLE 6 of the decryption computation performed by the receiver. TABLE 6 includes new data column 1302, encryption operator column 1304, encryption keys column 1306, and decryption transformation column 1508. In other embodiments, not all of the decryption computations in TABLE 6 are performed and/or other decryption computations may be performed instead of and/or in addition to those indicated in TABLE 6.

New data column 1302, encryption operator column 1304, and encryption keys column 1306 are the same as the corresponding columns in FIG. 13 that have the same column numbers, which were discussed in conjunction with FIG. 13, TABLE 4. Decryption transformation column 1508 shows the transformation applied by the receiver to reconstitute the encrypted data received from the sender. In the embodiment of FIG. 15, the decryption transformations are the same as the encryption transformations formed by encryption operator column 1304 and encryption keys column 1306. Thus, the computations performed to reconstitute the encrypted data in TABLE 4 are Mₘ·Kₚₘ₋ₚ₊₁·Kₚₘ₋ₚ₊₁, Kₚₘ₊₂·Kₚₘ₋ₚ₊₂·Kₚₘ₋ₚ₊₂, . . . Kₚₘ₊ₙ₊₁·Kₚₘ₊₁·Kₚₘ₊₁, which may also be the computations performed as part of step 1008 or 1112.

FIG. 16 shows a TABLE 7 of the decryption computation performed by the receiving machine 112. TABLE 7 includes new data column 1402, encryption operator column 1404, encryption keys column 1406, and decryption transformation column 1608.

TABLE 7 is an example of TABLE 6 in which p=2. New data column 1402, encryption operator column 1404, and encryption keys column 1406 are the same as the corresponding columns in FIG. 14 that have the same column numbers, which were discussed in conjunction with FIG. 14, TABLE 5. Decryption transformation column 1608 shows the transformation applied by the receiver to reconstitute the encrypted data received from the sender. In the embodiment of FIG. 16, the decryption transformations are the same as the encryption transformations formed by encryption operator column 1404 and encryption keys column 1406. Thus, in an embodiment, on the even (or the odd) values of m the computations performed to reconstitute the encrypted data are Mₘ·K₂ₘ₋₁·K₂ₘ₋₁, K₂ₘ₊₂·K₂ₘ·K₂ₘ, and K₂ₘ₊₃·K₂ₘ₊₁·K₂ₘ₊₁, which may also be the computations performed as part of step 1008 or 1112 on the odd (or the even) values of m (respectively) the computations performed to reconstitute the encrypted data are Mₘ·K₂ₘ·K₂ₘ, K₂ₘ₊₂·K₂ₘ₊₁·K₂ₘ₊₁, and K₂ₘ₊₃·K₂ₘ₋₁·K₂ₘ₋₁.

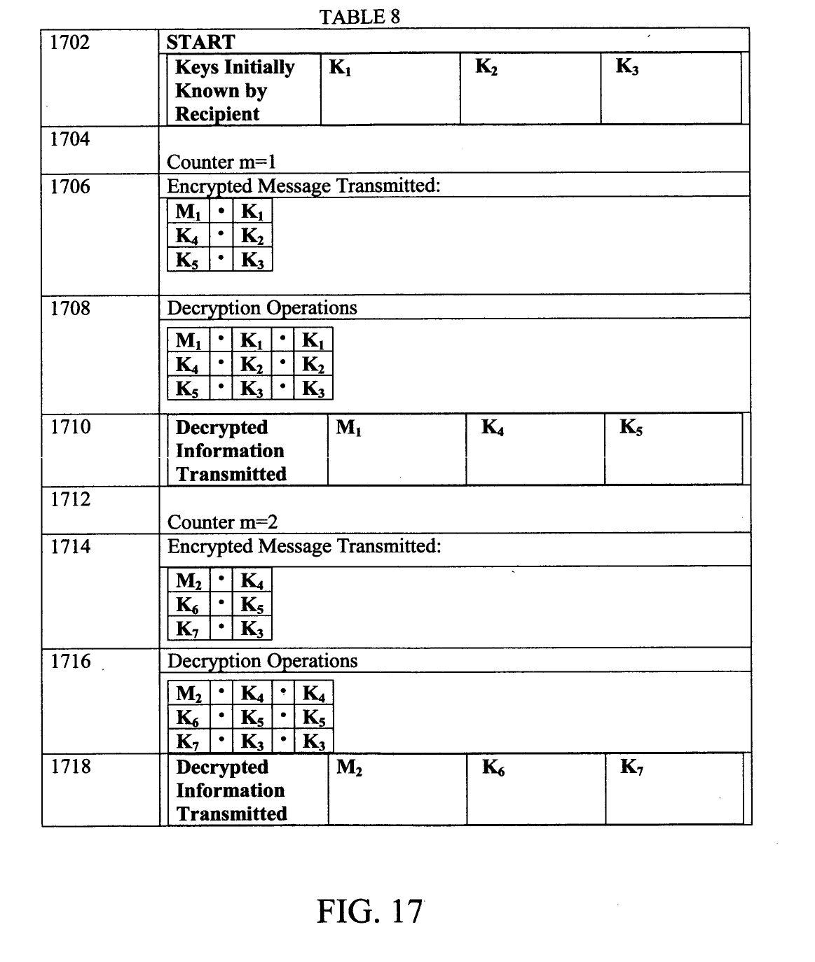

FIGS. 17 and 18 show TABLEs 8 and 9, respectively, which show an example of the first three transmissions for a situation in which two new keys are generated (which corresponds to p=2 in method 1100 of FIG. 11). The rows of TABLEs 8 and 9 are labeled consecutively, and represent aspects of states of message system 100. Later rows occur either chronologically later or simultaneously with rows that are earlier in TABLEs 8 and 9. Row 1702 indicates that at the start of the transmission keys K₁, K₂, and K₃ are known to both the sender and the receiver.

Row 1704 indicates that the counter m is set to 1. Row 1706 indicates that key K₄ and key K₅ are generated, and that message segment M₁, key K₄, and key K₅ are encrypted and sent to the receiver.

Sending machine 106 uses key K₁ to encrypt message M₁, key K₂ to encrypt key K₄, and key K₃ to encrypt key K₅. The encryptions of message segment M₁, key K₄, and key K₅ are performed by computing M₁·K₁, K₄·K₂, and K₅·K₃, respectively, as indicated in row 1704.

Row 1708 indicates that the encrypted message segment and encrypted keys of row 1706 are received and decrypted. Since receiving machine 112 possesses keys K₁, K₂, and K₃, receiving machine 112 uses key K₁ to decrypt the message segment M₁, key K₂ to decrypt the new key K₄, and key K₃ to decrypt the new key K₅. The decryption is performed by computing M₁·K₁·K₁, K₄·K₂·K₂, and K₅·K₃·K₃.

Row 1710 indicates that by performing the decryption, receiving machine 112 now obtains message segment M₁, new key K₄, and new key K₅. Rows 1712, 1714, 1716, and 1718 are similar to rows 1704, 1706, 1708, and 1710, respectively. However, now the m=2, and consequently, the current message segment is M₂, the new keys are K₆ and K₇. Additionally, since m is currently an even number, the relationship between the indices of the new keys and the indices keys used to encrypt the new keys and relationship between the index of the current message segment and the index of the key used to encrypt the current message segment is different than in the prior transmission in which m was an odd number. Consequently, since m=2, and since keys K₄ and K₅ are now in the possession of receiving machine 112, now the encrypted message segment is M₂·K₄, the encrypted keys are K₆·K₅ and K₇·K₃, and the decryption computations are M₂·K₄·K₄, K₆·K₅·K₅, and K₇·K₃·K₃. Consequently, the information obtained by receiving machine 112 is message segment M₂ the new keys are K₆ and K₇.

FIG. 18, TABLE 9, shows the next increment of counter m, in which m=3. Rows 1802, 1804, 1806, and 1808 are essentially a repetition of rows 1704, 1706, 1708, and 1710, respectively. However, since the m=3, the current message segment is M₃, the new keys are K₈ and K₉. Similarly, since m=3 and since keys K₆ and K₇ are now in the possession of receiving machine 112, now the encrypted message segment is M₃·K₅, the encrypted keys are K₈·K₆ and K₉·K_{7,} and the decryption computations are M₃·K₅·K₅, K₈·K₆·K₆, and K₉·K₇·K₇. Consequently, the information obtained by receiving machine 112 is message segment M₃ the new keys are K₈ and K₉. This process can be repeated for each message segment.

In another embodiment, each group of keys is used to form a set of one or more composite keys that encrypted the new keys and the message. If there are p+1 keys in each group, each composite key may be composed of any number of keys from 2 to p. If p+1 keys were included in all composite key, all of the composite key would be the same. Different composite keys may be encrypted with different numbers of keys. Thus, new key Kₚₘ₊₂ may be encrypted with a composite key made of two keys, new key Kₚₘ₊₃ may be encrypted with a composite key made of three keys, while new key Kₚₘ₊₃ may be encrypted with only one key.

FIGS. 18B(1)-F show examples of a series of transmissions according to different embodiments in which composite keys are used.

In the embodiment of FIGS. 18B(1) and 18B(2), at a given value of counter m, keys Kₘ, Kₘ₊₁, and Kₘ₊₂ are already known. The new key is Kₘ₊₃. Message segment Mₘ is encrypted and sent as Mₘ·Kₘ and new key Kₘ₊₃ is encrypted and sent as Kₘ₊₃·(Kₘ₊₁·Kₘ₊₂). In other words, composite key (Kₘ₊₁·Kₘ₊₂) is used for encrypting new key Kₘ₊₃.

In the embodiment of FIG. 18C, at a given value of counter m, keys Kₘ, Kₘ₊₁, and Kₘ₊₂ are already known. The new key is Kₘ₊₃. Message segment Mₘ is encrypted and sent as Mₘ·Kₘ·Kₘ₊₂ and new key Kₘ₊₃ is encrypted and sent as Kₘ₊₃·(Kₘ₊₁·Kₘ₊₂). In other words, composite key (Kₘ·Kₘ₊₂) is used for encrypting new key Mₘ, composite key (Kₘ₊₁·Kₘ₊₂) is used for encrypting new key Kₘ₊₃.

In the embodiment of FIGS. 18D and E, FIG. 18E is a continuation of the sequence of transmissions that starts in FIG. 18D. At a given value of counter m, keys Kₘ, Kₘ₊₁, and Kₘ₊₂ are already known. The new key is Kₘ₊₃. Composite key Q is updated according to the equation Q=Q·Kₘ. In other words, when m=1 Q=K₁. and when m is equal to any value of m greater than 1, Q=K₁·K₂ . . . ·Kₘ. Message segment Mₘ is encrypted and sent as Mₘ·Q·Kₘ₊₁ and new key Kₘ₊₃ is encrypted and sent as Kₘ₊₃·(Kₘ·Kₘ₊₂). In other words, composite key (Q·Kₘ₊₁) is used for encrypting new key Mₘ, and composite key (Kₘ·Kₘ₊₂) is used for encrypting new key Kₘ₊₃.

In the embodiment of FIG. 18F, at a given value of counter m, keys Kₘ, K₂ₘ, K₂ₘ₊₁, K₂ₘ₊₂, are already known. The new keys are K₂ₘ₊₃ and K₂ₘ₊₄. Message segment Mₘ is encrypted and sent as Mₘ·Kₘ, new key K₂ₘ₊₃ is encrypted and sent as K₂ₘ₊₃·(K₂ₘ·K₂ₘ₊₁), and new key K₂ₘ₊₄ is encrypted and sent as K₂ₘ₊₄·(K₂ₘ₊₁·K₂ₘ₊₂). In other words, composite key (K₂ₘ·K₂ₘ₊₁) is used for encrypting new key K₂ₘ₊₃ and composite key (K₂ₘ₊₁·K₂ₘ₊₂) is used for encrypting new key K₂ₘ₊₄.

In another embodiment, a portion of each message segment is encrypted with a different one of the keys of the current group of keys as long as there are at least as many bits in the message segment as there are keys. If the keys are longer than the portions of the message segment, then each portion is padded with other data (e.g., a string of 0s).

In FIGS. 13-18F although the same symbol is used for operator·, each operator· that is in a different row may be different for the operator· in another row. Two operators· that share the same row of the same table are either the same operator or inverse operators of one another.

FIG. 19 shows a flowchart of an embodiment of a method 1900 for exchanging messages without necessarily exchanging any keys. In this embodiment, collection of keys 105 includes at least one key, Kₛ, that is known by sending machine 106 but is expected not to be known by receiving machine 112. Similarly, key 118 includes at least one key, Kᵣ, which is known by receiving machine 112 but is expected not to be known by sending machine 106. Additionally, encryption algorithm 104 is capable of reconstituting messages, and message reconstitution algorithm 114 is capable of encrypting messages.

In step 1902, sending machine 106 encrypts unencrypted message 102 with a first encryption using the key Kₛ and encryption algorithm 104, and forms encrypted message 108. Prior to, or as part of, step 1902, unencrypted message 102 may have been generated at message machine 106 or entered into message machine 106 via a keyboard, electronic writing pad, mouse, LAN, WAN, telephone receiver, microphone, USB device, and/or other storage medium. In step 1904, sending machine 106 sends encrypted message 108, via transmission path 110, to receiver receiving machine 112.

In step 1906, receiving machine 112 receives encrypted message 108. Receiving machine 112 is expected to not be presently capable of decrypting encrypted message 108, because encrypted message 108 was encrypted by key Kₛ. Instead, in step 1908 receiving machine 112 further encrypts encrypted message 108 with a second encryption using message reconstitution algorithm 114 and key Kᵣ.

In step 1910, receiving machine 112 sends encrypted message 108 back to sending machine 106 (encrypted message 108 is now at least doubly encrypted by being encrypted with both the first and the second encryption). In step 1912, sending machine 106 receives encrypted message 108. In step 1914, sending machine 106 removes the first encryption, which is associated with key Kₛ, leaving encrypted message 108 encrypted with only one encryption. However, now encrypted message 108 has the second encryption, which was placed on encrypted message 108 by receiving machine 112 using key Kᵣ. In an embodiment, since the first and second encryption transformations are elements of a commutative group, once the sender removes the first encryption (while leaving the second encryption), the resulting encrypted message is no different than were the first encryption never used.

In step 1916, sending machine 106 sends encrypted machine 108, via transmission path 110, back to receiving machine 112. In step 1918, receiving machine 112 receives encrypted message 108. In step 1920, receiving machine 112 reconstitutes (e.g., decrypts) encrypted message 108 into reconstituted message 116 (which is expected to be unencrypted message 102) using message reconstitution algorithm 114 and key Kᵣ. In step 1922, receiving machine 112 reads reconstitute message 116. Step 1922 may include performing instructions in reconstituted message 116 and/or outputting the reconstituted message 116, such as by displaying reconstituted message 116 on a display, storing reconstituted message 116 in a file, and/or printing out reconstituted message 116 on paper.

To send multiple message segments, method 1900 may be applied multiple times. To conduct a two way communication, the sender and receiver just reverse roles, and messages are sent from receiving machine 112 to sending machine 106. Using method 1900 neither sending machine 106 nor receiving machine 112 needs to be aware of the key or encryption algorithm the other is using or how often the other changes keys or encryption algorithms. In other embodiments, method 1900 may not contain all of the steps above, and/or may contain other steps in addition to or instead of those specified above. For example, method 1900 may be performed by multiple modules in which each module performs only a part of method 1900. In such an embodiment, each module performs a method that only includes some of method 1900. Although in the above example, method 1900 is used in a situation in which key Kₛ is not known by the receiver and key Kᵣ is not know by the sender, method 1900 may also be used if sender knows key Kᵣ and/or if the receiver knows Kₛ.

As an example of method 1900, suppose the sender wants to transmit the message M=0011 1010 0101. Suppose also that the sender uses or creates keys A₁=1110, A₂=1011, and A₃=0110. Suppose the receiver uses or creates keys B₁=0010, B₂=0110, and B₃=1001. The sender divides M into three segments, which are M₁=0011, M₂=1010, M₃=0101. Suppose the sender's transformation uses the operator·=(⊕,⊕, [symbol] , [symbol] ) and the receiver's transformation uses the operator ∘=(⊕, [symbol] ,⊕, [symbol] ) and that these transformations stay constant for each segment.

Then the transmission of M from the sender to the receiver works as follows. The sender transmits the encrypted message segment M₁·A₁=0011 1110=1110 to the receiver. The receiver further encrypts the encrypted message segment with a second encryption, which is transmitted as (M₁·A₁)∘B₁=1110 0010=1001 back to the sender. The sender removes the first encryption by applying the transformation·A₁, resulting in the encrypted message segment ((M₁·A₁)∘B₁)·A₁=1001·1110=0100, which still has the second encryption and which is sent back to the receiver. The receiver decrypts the first message segment as (((M₁·A₁)∘B₁)·A₁)∘B₁=0100∘0010=0011, which completes the secure transmission of the first message segment M₁ of the message.

For the second message segment M₂, the sender encrypts message segment M₂ as M₂·A₂=1010·1011=0010, which is sent to the receiver. The receiver encrypts the message segment with the second encryption as (M₂·A₂)∘B₂=0010∘0110=0001, which is transmitted back to the sender. The sender removes the first encryption, resulting in the encrypted message segment ((M₂·A₂)∘B₂)·A₂=0001·1011=1001, which is sent back to the receiver. The receiver decrypts the second message segment by removing the second encryption, resulting in (((M₂·A₂)∘B₂)·A₂)∘B₂=1001∘0110=1010, which completes the secure transmission of the second message segment M₂ of the message.

For the third message segment M₃, the sender encrypts the third message segment with the first encryption, and transmits M₃·A₃=0101·0110=0000 to the receiver. The receiver further encrypts the third message segment with a second encryption, resulting in (M₃·A₃)∘B₃=0000∘1001=1100, which is transmitted back to the sender. The sender then removes the first encryption, resulting in ((M₃·A₃)∘B₃)·A₃=1100·0110=1001, which is sent back to the receiver. The receiver decrypts the third message segment by removing the second encryption, resulting in (((M₃·A₃)∘B₃)·A₃)∘B₃=1001∘1001=0101, which completes the secure transmission of the third and final message segment M₃ of the message M.

In some applications, method 1900 may be used for securely distributing one or more keys so that a sender and recover may subsequently communicate using cryptographic methods that assume that the sender and receiver already possess an initial set of one or more identical keys. In the cryptographic literature, methods in which the sender and receiver use an initial set of identical keys are sometimes called private key algorithms. As an example of a private key algorithm secure key distribution, suppose K is a 256-bit key for the AES cryptographic algorithm. Using method 1900, the sender creates an unpredictable or randomly generated key A, encrypts key K using the transformation ⊕A, and transmits encrypted key A, which is K⊕A, to the receiver. The receiver creates an unpredictable or randomly generated key B, which is used to further encrypt the encrypted key with a second encryption using transformation ⊕B, such that encrypted key A is now (K⊕A)⊕B. The receiver transmits the encrypted key (K⊕A)⊕B back to the sender. The sender removes the first encryption by applying ⊕A a second time, which results in encrypted key ((K⊕A)⊕B)⊕A=K⊕B. Next the sender sends encrypted key K⊕B back to the receiver. The receiver computes (K⊕B)⊕B=K so that now the receiver and sender both possess the 256-bit AES key K. Subsequently, the sender and receiver may proceed to securely communicate using the AES cryptographic algorithm, using key K. Similarly, a key may be sent via method 1900 from a first party to a second party, and then method 800 may be used for transmitting messages (using the key sent via method 1900) between the two parties. Method 1900 may also be used to securely distribute multiple keys. For example, the initial keys that the sender and receiver are assumed to both have in their possession before using methods 900, 1000, and 1100 and before the methods associated with the embodiments of FIGS. 18B(1)-F may be securely distributed using method 1900.

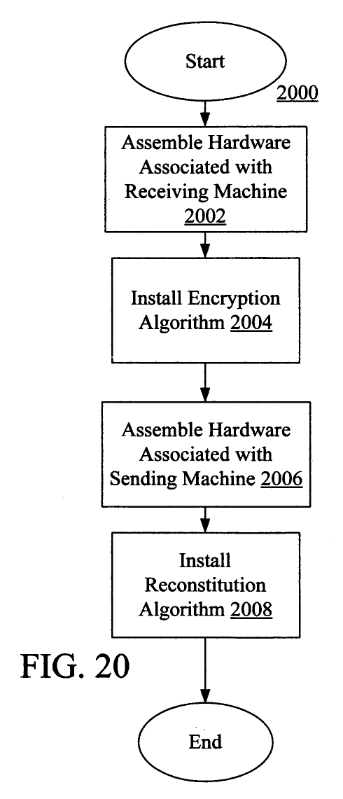

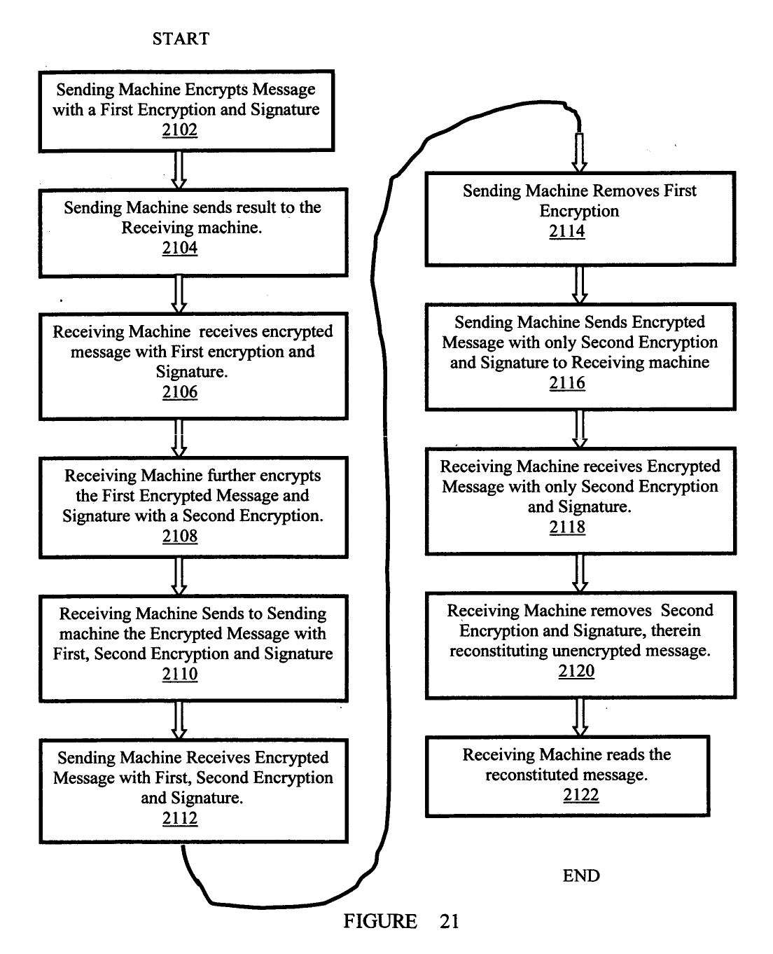

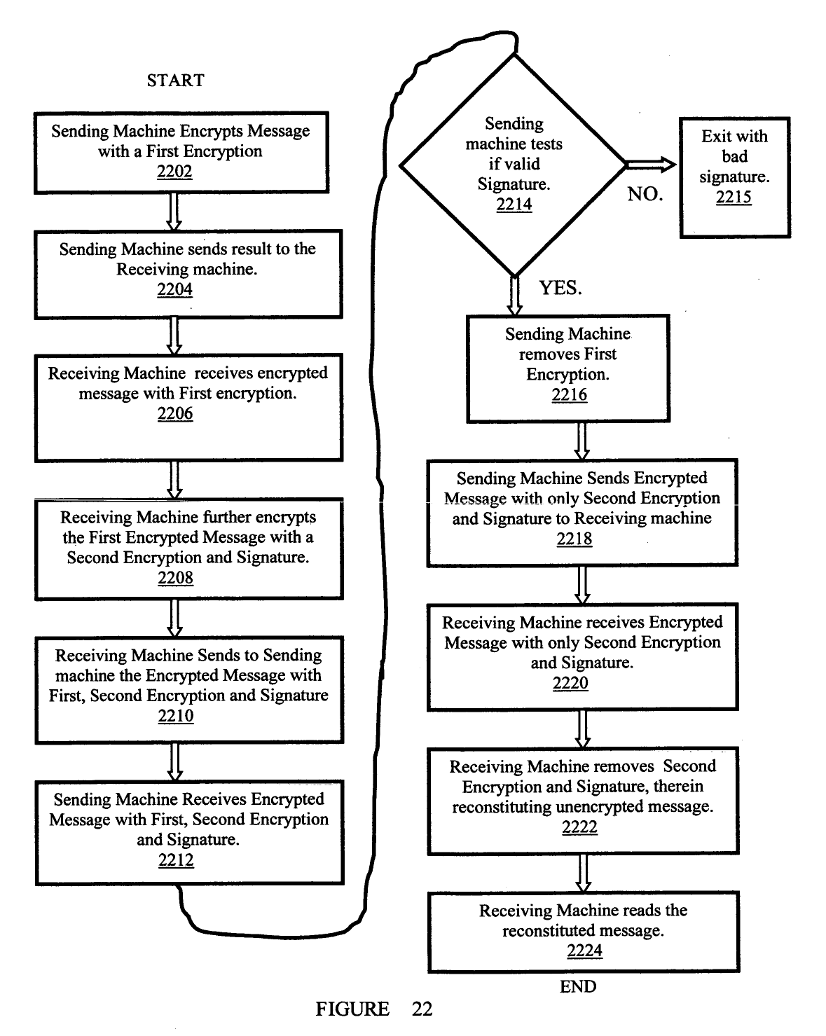

FIG. 20 shows a method 2000 of making message system 100. In step 2002 the hardware for sending machine 106 is constructed. Step 2002 may include assembling a machine, such as machine 600, which in turn may include assembling output system 602, input system 604, memory system 606, processor system 608, communication system 612, input/output system 614, and transformation module 616. Step 2002 may also include connecting together output system 602, input system 604, memory system 606, processor system 608, communication system 612, input/output system 614, and transformation module 616. In step 2004 encryption algorithm 104 is installed, which may include installing algorithm 200 and/or storing algorithm 200 within memory system 606.

In step 2006 the hardware for receiving machine 112 is constructed. Step 2006 may include assembling a machine such as machine 600, as described in step 2002. In step 2008 reconstitution algorithm 114 is installed, which may include installing algorithm 200 and/or storing algorithm 200 within memory system 606. After step 2008, method 2000 terminates. The pair of step 2006 and 2008 may be performed in any order (including simultaneously) with respect to the pair of steps 2002 and 2004. In other embodiments, method 2000 may not contain all of the steps above, and/or may contain other steps in addition to or instead of those specified above. For example, method 2000 may be performed by multiple modules in which each module performs only a part of method 2000. In such an embodiment, each module performs a method that only includes some of method 2000.

FIG. 21 shows a flowchart of an embodiment of a method 2100 for exchanging messages without necessarily exchanging any keys. In this embodiment, collection of keys 105 includes at least one key, Kₛ, that is known by sending machine 106 but is expected not to be known by receiving machine 112. Similarly, key 118 includes at least one key, Kᵣ, which is known by receiving machine 112 but is expected not to be known by sending machine 106. Additionally, encryption algorithm 104 is capable of reconstituting messages, and message reconstitution algorithm 114 is capable of encrypting messages.

In step 2102, sending machine 106 encrypts unencrypted message 102 with a first encryption using the key Kₛ and encryption algorithm 104, and forms encrypted message 108 with signature S. Prior to, or as part of, step 2102, unencrypted message 102 may have been generated at message machine 106 or entered into message machine 106 via a keyboard, electronic writing pad, mouse, LAN, WAN, telephone receiver, microphone, USB device, and/or other storage medium. In step 2104, sending machine 106 sends encrypted message 108 with signature, via transmission path 110, to receiver receiving machine 112.

In step 2106, receiving machine 112 receives encrypted message 108 with signature. Receiving machine 112 is expected to not be presently capable of decrypting encrypted message 108, because encrypted message 108 was encrypted by key Kₛ. Instead, in step 2108 receiving machine 112 further encrypts encrypted message 108 with a second encryption using message reconstitution algorithm 114 and key Kᵣ.

In step 2110, receiving machine 112 sends encrypted message 108 back to sending machine 106 (encrypted message 108 is now at least doubly encrypted by being encrypted with both the first and the second encryption and with signature). In step 2112, sending machine 106 receives encrypted message 108. In step 2114, sending machine 106 removes the first encryption, which is associated with key Kₛ, leaving encrypted message 108 encrypted with only one encryption and the signature. However, now encrypted message 108 has the second encryption, which was placed on encrypted message 108 by receiving machine 112 using key Kᵣ. In an embodiment, since the first and second encryption transformations are elements of a commutative group, once the sender removes the first encryption (while leaving the second encryption), the resulting encrypted message is no different than were the first encryption never used.

In step 2116, sending machine 106 sends encrypted message 108 with signature, via transmission path 110, back to receiving machine 112. In step 2118, receiving machine 112 receives encrypted message 108 with signature. In step 2120, receiving machine 112 reconstitutes (e.g., decrypts) encrypted message 108 with signature into reconstituted message 116 (which is expected to be unencrypted message 102) using message reconstitution algorithm 114 and key Kᵣ and signature S. In step 2122, receiving machine 112 reads reconstituted message 116. Step 2122 may include performing instructions in reconstituted message 116 and/or outputting the reconstituted message 116, such as by displaying reconstituted message 116 on a display, storing reconstituted message 116 in a file, and/or printing out reconstituted message 116 on paper.

To send multiple message segments, method 2100 may be applied multiple times. To conduct a two way communication, the sender and receiver just reverse roles, and messages are sent from receiving machine 112 to sending machine 106. Using method 2100 neither sending machine 106 nor receiving machine 112 needs to be aware of the key or encryption algorithm the other is using or how often the other changes keys or encryption algorithms. In other embodiments, method 2100 may not contain all of the steps above, and/or may contain other steps in addition to or instead of those specified above. For example, method 2100 may be performed by multiple modules in which each module performs only a part of method 2100. In such an embodiment, each module performs a method that only includes some of method 2100. Although in the above example, method 2100 is used in a situation in which key Kₛ is not known by the receiver and key Kᵣ is not know by the sender, method 2100 may also be used if sender knows key Kᵣ and/or if the receiver knows Kₛ.

As an example of method 2100, suppose the sender wants to transmit the message M=0011 1100 0101. Suppose also that the sender uses or creates keys A₁=1110, A₂=1011, and A₃=0110. Suppose the receiver uses or creates keys B₁=0010, B₂=0110, and B₃=1001.

The sender divides M into three segments, which are M₁=0011, M₂=1100, M₃=0101. Suppose the sender's transformation uses the operator·=(⊕,⊕,⊕,⊕) and the receiver's transformation uses the operator ∘=( [symbol] , [symbol] , [symbol] , [symbol] ) and that these transformations stay constant for each segment. In some embodiments, the operator(s) used by the transformation(s) may change for each segment. Suppose the sender and receiver both have access to signature S₁=0001 for the first message segment, signature S₂=1001 for the second message segment, and S₃=0111 for the third message segment. In this example, sender and receiver both agree to use sender's transformation operator· to add and remove signatures. In general, the transformation used to add and remove a signature may be a transformation as described in the sections following the description of a commutative group. A transformation that adds or removes a signature is called a signature transformation.

The transmission of M from the sender to the receiver works as follows. The sender transmits the encrypted message segment M₁·A₁·S₁=0011·1110·0001=1100 to the receiver. The first encryption transformation is computed with transformation·A_{1.} The signature transformation is computed with transformation·S₁. The receiver further encrypts the encrypted message segment with a second encryption transformation∘B₁, which is transmitted as (M₁·A₁·S₁)∘B₁=1100∘0010=0001 back to the sender. The sender removes the first encryption by applying the transformation·A₁, resulting in the encrypted message segment [(M₁·A₁·S₁)∘B₁]·A₁=0001·1110=1111, which still has the second encryption and the signature S₁ which is sent back to the receiver. The receiver decrypt the first message segment as [([(M₁·A₁·S₁)∘B₁]·A₁)∘B1]=1111∘0010=0010 by applying the second encryption transformation∘B₁. And subsequently, computes [([(M₁·A₁·S₁)∘B₁]·A₁)·B₁]·S₁=0010·0001=0011 by applying the signature transformation·S₁. This completes the secure transmission of the first message segment M₁ of the message.

For the second message segment M₂, the sender encrypts segment M₂ as M₂·A₂·S₂=1100·1011·1001=1110, and sends to the receiver. The first encryption transformation on the second message segment is computed with transformation·A_{2.} The signature transformation is computed with transformation·S₂. The receiver further encrypts the second message segment with a second encryption transformation ∘B₂ which is computed as (M₂·A₂·S₂)∘B₂=1110010∘0110=0111, and transmits back to the sender. The sender removes the first encryption by applying the transformation·A₂, resulting in the encrypted message segment [(M₂·A₂·S₂)∘B₂]·A₂=0111·1011=1100, and sends this back to the receiver. The receiver decrypts the second message segment by removing the second encryption with transformation∘B₂, resulting in ([(M₂·A₂·S₂)∘B₂]·A₂)∘B₂=1100∘0110=0101. Then it removes the signature S₂ by applying signature transformation·S₂, computed as [([(M₂·A₂·S₂)∘B₂]·A₂)∘B₂]·S₂=0101·1001=1100. This completes the secure transmission of the second message segment M₂ to the receiver.

For the third message segment M₃, the sender encrypts segment M₃ as M₃·A₃·S₃=0101·0110·0111=0100, and sends to the receiver. The first encryption transformation on the third message segment is computed with transformation·A_{3.} The signature transformation is computed with transformation·S₃. The receiver encrypts the message segment with the second encryption transformation∘B₃, computed as (M₃·A₃·S₃)∘B₃=0100∘1001=0010, and transmits back to the sender. The sender removes the first encryption transformation·A₃, resulting in the encrypted message segment [(M₃·A₃·S₃)∘B₃]·A₃=0010·0110=0100, and sends this result back to the receiver. The receiver decrypts the second message segment by applying the second transformation∘B₃, resulting in ([(M₃·A₃·S₃)∘B₃]·A₃)∘B₃=0100∘1001=0010. Then it removes the third signature S₃ by applying signature transformation·S₃, computed as [([(M₃·A₃·S₃)∘B₃]·A₃)∘B₃]·S₃=0010·0111=0101. This completes the secure transmission of the third and final message segment M₃ of the message M.

FIG. 22 shows a flowchart of an embodiment of a method 2200 for securely transmitting messages. In this embodiment, collection of keys 105 includes at least one key, Kₛ, that is known by sending machine 106 but is expected not to be known by receiving machine 112 or any other party. Similarly, key 118 includes at least one key, Kᵣ, which is known by receiving machine 112 but is expected not to be known by sending machine 106. Additionally, encryption algorithm 104 is capable of reconstituting messages, and message reconstitution algorithm 114 is capable of encrypting messages.

In step 2202, sending machine 106 encrypts unencrypted message 102 with a first encryption transformation·Kₛ, using the key Kₛ and encryption algorithm 104, and forms encrypted message 108. Prior to, or as part of, step 2102, unencrypted message 102 may have been generated at message machine 106 or entered into message machine 106 via a keyboard, electronic writing pad, mouse, LAN, WAN, telephone receiver, microphone, USB device, and/or other storage medium. In step 2204, sending machine 106 sends encrypted message 108, via transmission path 110, to receiver receiving machine 112.

In step 2206, receiving machine 112 receives encrypted message 108. Receiving machine 112 is expected to not be presently capable of decrypting encrypted message 108, because encrypted message 108 was encrypted by the first transformation, ·Kₛ which is only known to the sending machine. Instead, in step 2208 receiving machine 112 further encrypts encrypted message 108 with a second encryption using message reconstitution algorithm 114 and transformation ∘Kᵣ and also places a signature S on it.

In step 2210, receiving machine 112 sends encrypted message 108 back to sending machine 106 (encrypted message 108 is now at least doubly encrypted by being encrypted with both the first and the second encryption and with signature). In step 2212, sending machine 106 receives encrypted message 108. In step 2214, sending machine 106 tests if the signature placed by the receiving machine is valid.

If the signature is valid, then in step 2216, sending machine 106 removes the first encryption transformation·Kₛ, generated from key Kₛ, leaving encrypted message 108 encrypted with only one encryption and the signature. However, now encrypted message 108 has the second encryption transformation and signature, which was placed on encrypted message 108 by receiving machine 112. In an embodiment, since the first, second encryption and signature transformations are elements of a commutative group, once the sender removes the first encryption (while leaving the second encryption and the signature), the resulting encrypted message is no different than were the first encryption never used.

If the signature is not valid, then in step 2215, the sending machine notifies the receiving machine of a bad signature and exits. In other embodiments, the sending machine may request another transmission with second encryption and valid signature.

In step 2218, sending machine 106 sends encrypted message 108 with signature, via transmission path 110, back to receiving machine 112. In step 2220, receiving machine 112 receives encrypted message 108 with signature. In step 2222, receiving machine 112 reconstitutes (e.g., decrypts) encrypted message 108 with signature into reconstituted message 116 (which is expected to be unencrypted message 102) using message reconstitution algorithm 114 and transformation ∘Kᵣ and signature S. In step 2224, receiving machine 112 reads reconstituted message 116. Step 2224 may include performing instructions in reconstituted message 116 and/or outputting the reconstituted message 116, such as by displaying reconstituted message 116 on a display, storing reconstituted message 116 in a file, and/or printing out reconstituted message 116 on paper.

To send multiple message segments, method 2200 may be applied multiple times. To conduct a two way communication, the sender and receiver just reverse roles, and messages are sent from receiving machine 112 to sending machine 106. Using method 2200 neither sending machine 106 nor receiving machine 112 needs to be aware of the key(s), transformation(s) or encryption algorithm(s) the other is using or how often the other changes keys, transformations or encryption algorithms. In other embodiments, method 2200 may not contain all of the steps above, and/or may contain other steps in addition to or instead of those specified above. For example, method 2200 may be performed by multiple modules in which each module performs only a part of method 2200. In such an embodiment, each module performs a method that only includes some of method 2200. Although in the above example, method 2200 is used in a situation in which key Kₛ and transformation·Kₛ is not known by the receiver and key Kᵣ and transformation ∘Kᵣ is not known by the sender, method 2200 may also be used if sender knows key Kᵣ and/or if the receiver knows Kₛ.

In this example of method 2200, Haley and Joanne may be a person, a computer, a software program, an electronic device or another kind of machine. Joanne can generate or has a signature S that Haley can validate and an outsider does not know S or does not have the ability to generate S.
Step 1.) Haley generates key A and encrypts (locks) the message M with transformation·A. The encrypted message is M·A. Haley sends M·A to Joanne.
Step 2.) Joanne receives the encrypted message M·A. Joanne key B and encrypts (locks) the message with transformation ∘B and also places signature transformation ∘S on the encrypted message. The encrypted message is now (M·A)∘(B∘S). Joanne transmits (M·A)∘(B∘S) to Haley.
Step 3.) Haley receives the encrypted message (M·A)∘(B∘S). Haley uses key A (unlocks the A lock), the same bit string used in step 1, and applies transformation·A to (M·A)∘(B∘S). After this operation, the encrypted message is (M·A)∘(B∘S)·A, which is equivalent to M∘(B∘S), so the information is still encrypted. Haley checks that signature S is valid. If signature S is valid, then Haley transmits M∘(B∘S) back to Joanne. If S is not valid, then Haley notifies Joanne of an invalid signature. Haley may ask Joanne to resend with new second encryption key C and valid signature S. Or Haley may stop communicating with Joanne.
Step 4.) If a valid signature, Joanne receives the encrypted message M∘(B∘S). Joanne applies transformation ∘(B∘S) to M∘(B∘S) and reconstitutes message M. Consequently, Joanne may read message M.

There are number of methods for creating or generating signatures. Some methods and embodiments are described in what follows.

In some embodiments, signature S may be derived from user information pertaining to Haley, Joanne or both. In some cases, signature S may be generated by applying a one-way function to a biometric invariant that both Haley and Joanne have knowledge of. A hash function, denoted φ, is a function that accepts as its input argument an arbitrarily long string of bits (or bytes) and produces a fixed-size output. In other words, a hash function maps a variable length message μ to a fixed-sized output, φ(μ). One example is SHA-512 which has an output size of 512 bits.

An ideal hash function is a function Φ whose output is uniformly distributed in the following manner. Suppose the output size of Φ is n bits. If the point μ is chosen randomly, then for each of the 2^{v} possible outputs ζ, the probability that φ(μ)=ζ is 2^{-v}.

The hash functions that are used are one-way. A one-way function φ has the property that given a range (output) value ζ, it is computationally extremely difficult to find a point μ such that φ(μ)=ζ. In other words, a one-way function Φ is a function that can be easily computed, but that its inverse φ⁻¹ is extremely difficult to compute. For some embodiments, suppose ρ denotes a string or sequence of bits. φ^{k} denotes that the one-way function Φ is applied k times to input ρ. For example, when k=3, then φ^{k}(ρ) means φ(φ(φ(ρ)). In other embodiments, a one-way function may be used that does not have a fixed output size. In some cases, this output could be truncated if the signature used is a constant length.

In some embodiments, a third party authenticator may know both unique information or common knowledge about Haley and Joanne. In some cases, the third party authenticator may be implemented similar to a search engine where a specific set of URL(s) lead to a website that knows how to execute the same cryptographic operations that Haley and Joanne can execute. In some embodiments, this third party authenticator may verify signatures that Haley and or Joanne place on the messages before forwarding them on to the other party. The third party authenticator is helpful when Haley and Joanne do not know anything about each other so they can use the third party authenticator to verify signatures, similar to a notary public which verifies and/or witnesses the authenticity of a particular person's execution of a contact, signature or other legal document.

A current public key cryptography such as RSA or Elliptic Curve Cryptography may be used to generate and securely distribute a signature S. In some embodiments, public key cryptography may also be used to create and distribute a signature from the third party authenticator to the sender and receiver.

Below is a brief description of Elliptic Curve Cryptography (ECC) that helps securely distribute a signature S or may generate a signature S that the other party can verify. In ECC, the Diffie-Hellman assumption holds for elliptic curves of the form y²=x³+ax+b.

Compute point Q where Q=UP for some integer U where 0<U<n and n is the order of P.

ECC Encryption Steps. Public key (P, Q).

| | |
|---|---|
| Step A. | Select a random integer w such that 0 < w < n |
| Step B. | Compute R = wP and Z = wQ |
| Step C. | If Z = 0, go back to step A. and repeat the steps. |
| Step D. | Compute S = κ(x(Z), R), where x(Z) is the x-coordinate |
| | of Z and κ is a signature derivation function constructed |
| | from a one-way hash function. |

ECC Decryption Steps. Public key (P, Q)
and Secret key U. Output: Signature S.

| | |
|---|---|
| Step a. | Compute Z = UR |
| Step b. | Compute S = κ(x(Z), R) where x(Z) is the x-coordinate |
| | of Z and κ is a signature derivation function constructed |
| | from a one-way hash function. |

In methods 800, 900, 1000, 1100, 1900, 2100 and 2200, other embodiments may be obtained by substituting physical keys and/or electronic keys that open and close physical locks, which are used to lock containers, within which the messages and (in the case of methods 900, 1000, and 1100) the new keys are locked and transferred between a sender and a receiver. Also, in methods 800, 900, 1000, 1100, 1900, 2100, 2200 the encrypted messages and encrypted keys (or the locked messages and the locked keys) may never change locations. Instead the sender and receiver may visit a particular location to retrieve and/or place the locked and/or encrypted messages and/or keys.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A machine-implemented method comprising:
receiving an encrypted message; and
decrypting the message by performing a set of one or more operations, wherein the set of one or more operators obey the commutative law.

2. The machine implemented method of claim 1, wherein a transformation, that is its own inverse, is composed of one or more said operators.

3. The machine implemented method of claim 1, wherein a transformation is composed of one or more said operators and at least one operator obeys the associative law.

4. The machine implemented method of claim 1, wherein said set of one or more operations is identical to another set of one or more operations that are performed in order to encrypt the message.

5. The machine implemented method of claim 1, wherein:
at least one transformation, that is an inverse of itself, and that is performed by said operations, contains an operator that obeys the associative law.

6. A machine-readable medium storing thereon one or more instructions, which when implemented cause a processor to carry out the method of claim 1.

7. The machine implemented method of claim 1, wherein: the message was encrypted using operator(s) or transformation(s) generated using quantum properties generated by a physical system.

8. A machine-implemented method comprising:
from a set of transformations that obey the commutative law, a transformation is selected to encrypt a message.

9. The machine implemented method of claim 8, wherein said set of transformations has at least one transformation that is its own inverse.

10. The machine implemented method of claim 8, wherein said set of transformations obeys the associative law.

11. The machine implemented method of claim 8, wherein each transformation in said set of transformations has a unique inverse transformation.

12. The machine implemented method of claim 8, wherein the transformation used to decrypt said encrypted message is the same transformation used to encrypt said message.

13. The machine implemented method of claim 8, wherein said transformation is generated using quantum properties of a physical system.

14. The machine implemented method of claim 13, wherein said quantum properties are caused by photons.

15. The machine implemented method of claim 8, wherein said transformation is generated using an unpredictable system.

16. The machine implemented method of claim 8, wherein a signature transformation, selected from said set of transformations, is applied to said encrypted message.

17. The machine implemented method of claim 16, wherein a dynamical system is used to select said signature transformation.

18. A machine-readable medium storing thereon one or more instructions, which when implemented cause a processor to carry out the method of claim 8.

19. A machine implemented method comprising:
sending an encrypted message, wherein the encrypted message is encrypted with a first encryption; and
receiving the encrypted message after sending the encrypted message, wherein the encrypted message received is encrypted with a second encryption that was not present during the sending.

20. The method of claim 19, wherein the sending of the encrypted message includes at least sending of the message for a first time, the method further comprising:
after the receiving of th encrypted message, sending the encrypted message for the second time.

21. The machine-implemented method of claim 19, further comprising:
at a location associated with the sending, removing the first encryption after the receiving.

22. The machine-implemented method of claim 19, further comprising:
placing a signature on the encrypted message before it is sent.

23. The machine-implemented method of claim 22, further comprising:
said signature was generated using a dynamical system.

24. The machine-implemented method of claim 23, further comprising:
said method uses a one-way function.

25. The machine-implemented method of claim 19, wherein
the sending of the encrypted message includes at least sending of the encrypted message for a first time,
the sending of the encrypted message for the first time is associated with a location, and the method further comprises:
after the receiving of the encrypted message, at the location removing the first encryption, and
sending the encrypted message for the second time, wherein the encrypted message has the first encryption removed.

26. The machine implemented method of claim 19, wherein the encrypted message is an encrypted key.

27. The machine-implemented method of claim 19, wherein the encrypted message is a first encrypted message, which is an encrypted key, which in turn is a key that was encrypted, and the method further comprises:
encrypting a second message with the key therein forming a second encrypted message; and
sending the second encrypted message.

28. The machine-implemented method of claim 27, further comprising:
receiving the second encrypted message; and
decrypting the second encrypted message with the key.

29. A machine-readable medium string thereon one or more instructions, which when implemented cause a processor to carry out the method of claim 19.

30. The machine-implemented method of claim 19, wherein
the sending is associated with a first location,
the receiving is associated with a second location, and
the method further comprises:
receiving the encrypted message at a second location as a result of the sending from the first location, wherein the receiving at the second location is a first receiving at the second location for a first time;
encrypting the encrypted message with a second encryption, wherein the encryption with the second encryption is associated with the second location;
placing a signature on the encrypted message at the second location;
sending the encrypted message from the second location back to the first location, wherein the encrypted message is encrypted with the first encryption and the second encryption and has a signature placed on it;
after the receiving of the encrypted message at the first location, removing the first encryption from the encrypted message only if the signature placed at the second location is valid, wherein after the removing the encrypted message is encrypted with the second encryption, but is not encrypted with the first encryption;
sending the encrypted message from the first location to the second location with the second encryption, but without the first encryption;
receiving the encrypted message at the second location for a second time;
removing the second encryption and signature from the encrypted message, which is at the second location, therein forming a reconstituted message; and
reading the reconstituted message via a process associated with the second location.

31. The machine-implemented method of claim 30, wherein the reconstituted message is a first message which is a key, and the method further comprises:
encrypting a second message with the key therein forming a second encrypted message;
sending the second encrypted message from the first location to the second location;
receiving the second encrypted message at the second location; and
decrypting the second encrypted message with the key at the second location.
